(19) United States
(12) Patent Application Publication
(10) Pub. No.: US 2015/0232582 A1
(43) Pub. Date: Aug. 20, 2015

(54) Hemicellulose Compositions

(71) Applicant: Celanese Acetate LLC, Irving, TX (US)

(72) Inventors: Denis G. Fallon, Blacksburg, VA (US); Leslie Allen, Blacksburg, VA (US); Dinesh Arora, League City, TX (US); Monica Boatwright, Blacksburg, VA (US); Christopher M. Bundren, Blacksburg, VA (US); Michael T. Combs, Shady Spring, WV (US); Bin Li, Blacksburg, VA (US); Rongfu Li, Blacksburg, VA (US); Jay Mehta, Blacksburg, VA (US); Tianshu Pan, Charlotte, NC (US)

(21) Appl. No.: 14/527,954

(22) Filed: Oct. 30, 2014

Related U.S. Application Data
(60) Provisional application No. 61/941,948, filed on Feb. 19, 2014.

(51) Int. Cl. C08B 37/00

(52) U.S. Cl. CPC C08B 37/0057

(57) ABSTRACT

Hemicellulose compositions are prepared by treating a cellulosic material with an extractant comprising a cellulose solvent and co-solvent. The hemicellulose compositions preferably comprise from 55 to 99 wt. % xylan and have distinct molecular weights, elemental metal ions, and intrinsic viscosities when compared to known hemicellulose compositions.

### CROSS REFERENCE TO RELATED APPLICATIONS

This application claims priority to U.S. Provisional App. No. 61/941,948, filed Feb. 19, 2014, the entirety of which is incorporated herein by reference.

### FIELD OF THE INVENTION

The present invention relates generally to hemicellulose compositions and to processes for producing hemicellulose compositions. In particular, the present invention relates to hemicellulose compositions comprising increased xylan content.

### BACKGROUND OF THE INVENTION

Hemicellulose is a highly abundant heteropolymer comprising C₅ and C₆ monosaccharide units. In contrast to cellulose, which is a polymer of glucose, hemicellulose is a heterogeneous polymer comprising several different sugars, and its specific composition can vary depending on its source. Compared with cellulose, hemicellulose contains short, highly branched chains of sugars. Hemicellulose primarily contains five-carbon sugars (typically D-xylose and L-arabinose) and six-carbon sugars (D-galactose, D-glucose, D-fructose, L-rhamnose, and D-mannose). The sugars may include polysaccharides, such as xylan, arabinan, galactan, glucan, and mannan. Xylose is the primary sugar monomer present in hemicellulose derived from hardwoods. Hemicellulose may be extracted from a variety of plant materials, including wood pulp and cotton and may be further modified or treated for downstream use.

Generally, wood comprises from 23 to 32 wt. % hemicellulose, 38 to 50 wt. % cellulose and 15 to 25 wt. % lignin, depending on the type of wood, e.g., hardwood or softwood. Although hemicellulose is abundant, manufacturing costs for purifying hemicellulose have limited the viability of hemicellulose as a commercial product. Typically, hemicellulose is extracted, e.g., using an alkali or hot water process, and is then hydrolyzed by diluted sulfuric acid.

U.S. Pat. No. 7,812,153 discloses a process for manufacturing xylose by extracting hemicellulose from a cellulosic material, such as by a cold caustic extraction method, concentrating the extract, such as by nanofiltration, into a hemicaustic stream containing hemicellulose with greater than about 85 wt. % xylan content, and subsequently hydrolysing the xylan from the hemicaustic stream to xylose. The high concentration of xylan within the concentrated hemicaustic stream enables hydrolyzation of the xylan to food-grade xylose and, optionally, hydrogenation of the xylose to xylitol without the need of a chromatographic separation step as previously required.

U.S. Pub. No. 2013/0174993 discloses a process of separating one or more components of corn fiber that comprises contacting the corn fiber with an extraction fluid that comprises at least one weak acid, increasing the temperature of the resulting mixture of fiber and fluid to solubilize hemicellulose of the corn fiber into the fluid, cooling the mixture, and separating the cooled extraction mixture into a soluble fraction comprising dissolved hemicellulose and an insoluble fraction comprising cellulose.

CN103159865 discloses hemicellulose and a preparation method of the hemicellulose. The preparation method of the hemicellulose comprises the following steps: firstly, enabling wooden lignocellulose raw materials to start high temperature sterilization process, and then placing white rot fungus and standing and cultivating for different time periods, and further acquiring water-solubility hemicellulose by using water digestion to a biomass component after degradation. The hemicellulose acquired from the preparation method of the hemicellulose has the advantages of being simple in chemical structure, and high in hemicellulose productivity. In addition, the hemicellulose and the preparation method of the hemicellulose discloses structure change of the hemicellulose in the process of degradation of the white rot fungus, provides novel thoughts for exploring that the wooden fiber raw materials produce biological fuel and prepare biological materials through a biological transformation method, and further provides referential significance for well protecting timber resources from degradation by germs.

Depending on the desired use of the hemicellulose, different polysaccharide content may be desired. For example, U.S. Pub. No. 2013/0172582 discloses processes for making furfural and 5-hydroxymethylfurfural from sugars. The processes can be carried out using a batch process or a continuous mode of operation. An aqueous sugar solution is pressurized with CO₂, thereby producing carbonic acid in situ that catalyzes the dehydration reaction to produce furfural from C₅ sugars and 5-methylhydroxyfurfural from C₆ sugars.

There are numerous examples in the prior art of methods of indiscriminately dissolving both cellulose and hemicellulose in pulps. S. Zhu et al. in Green Chem. 2006, 8, pp. 325-327, describe the possibility of dissolving cellulose in ionic liquids and recovering it by addition of suitable precipitating agents such as water, ethanol, or acetone. U.S. Pub. No. 2010/0112646 discloses a process for preparing glucose from a cellulose material, in which a cellulose-comprising starting material is provided and treated with a liquid treatment medium comprising an ionic liquid and an enzyme. Similarly, U.S. Pub. No. 2010/0081798 discloses a process for preparing glucose from a material containing ligno-cellulose, in which the material is first treated with an ionic liquid and then subjected to enzymatic hydrolysis. U.S. Pub. No. 2010/0081798 describes obtaining glucose by treating a material containing ligno-cellulose with an ionic liquid and subjecting same to an enzymatic hydrolysis and fermentation. U.S. Pat. No. 7,828,936 describes a method for dissolving cellulose in which the cellulose based raw material is admixed with a mixture of a dipolar aprotic intercrystalline swelling agent and an ionic liquid.

However, by indiscriminately dissolving cellulose along with hemicellulose, the cellulose fiber morphology is destroyed, undesirably reducing cellulose crystallinity, resulting in cellulose that is unsuitable for many uses, e.g., making cellulose derivatives.

Thus, the need exists for hemicellulose compositions comprising at least 55 wt. % xylan and for processes for producing such hemicellulose compositions. In particular, the need exists for cost effective processes for removing and recovering hemicellulose from cellulosic materials to yield hemicellulose compositions comprising at least 55 wt. % xylan and also recovering high purity cellulose that can be converted, for example, to commercially desirable cellulose derivatives.

### SUMMARY OF THE INVENTION

In a first embodiment, the invention is directed to a hemicellulose composition comprising from 55 to 99 wt. % xylan, based on the dried weight of the hemicellulose composition. In some aspects, the hemicellulose composition comprises from 55 to 80 wt. % xylan. The hemicellulose composition may comprise less than 0.3 wt. % mannan or less than 0.1 wt. % mannan. The hemicellulose composition may comprise less than 5 wt. % glucan. The composition optionally comprises less than 0.1 wt. % arabinan. The hemicellulose composition may comprise a weight ratio of xylan to mannan that is at least 200:1 or at least 500:1. The hemicellulose composition may have a weight average molecular weight from 20,000 to 35,000 g/mol. The hemicellulose composition may have a number average molecular weight from 10,000 to 40,000 g/mol or from 15,000 to 25,000 g/mol. The hemicellulose composition may have a Z-average molecular weight from 20,000 to 45,000 g/mol. The hemicellulose composition may have an intrinsic viscosity of at least 0.3 or at least 0.34. The hemicellulose composition may comprise less than 5000 ppm sodium or less than 250 ppm sodium. The hemicellulose composition may comprise less than 5000 ppm potassium, less than 70 ppm potassium, or less than 10 ppm potassium. The hemicellulose composition may be derived from a hardwood pulp or a softwood pulp.

In a second embodiment, the invention is directed to a hemicellulose composition comprising from 55 to 99 wt. % xylan, preferably from 55 to 80 wt. %, less than 0.3 wt. % mannan, preferably less than 0.1 wt. %, less than 5 wt. % glucan and less than 0.1 wt. % arabinan. The hemicellulose composition may have a weight ratio of xylan to mannan of at least 200:1, at least 500:1 or from 200:1 to 2000:1.

The hemicellulose compositions may be used for composite materials or may be incorporated into a hydrogel.

### BRIEF DESCRIPTION OF THE DRAWING

The present invention will be better understood in view of the appended non-limiting figures, in which:

FIG. 1 shows an exemplary purification process in accordance with one embodiment of the present invention;

FIG. 2 shows an exemplary purification process in accordance with another embodiment of the present invention; and

FIG. 3 shows an exemplary purification process in accordance with yet another embodiment of the present invention.

### DETAILED DESCRIPTION OF THE INVENTION

### I. Introduction

The present invention relates to hemicellulose compositions and to processes for producing hemicellulose compositions. The hemicellulose compositions preferably have an increased amount of xylan as compared to the cellulose compositions from which they may be derived and as compared to known and/or commercially available hemicellulose compositions. Further, the hemicellulose compositions of the present invention have distinct molecular weights, intrinsic viscosities, and elemental metal contents from known and/or commercially available hemicellulose compositions.

In some embodiments, the hemicellulose composition may comprise from 55 to 99 wt. % xylan. In other embodiments, the hemicellulose composition may have a weight ratio of xylan to mannan from 200:1 to 2000:1. In yet further embodiments, the hemicellulose composition may comprise from 55 to 99 wt. % xylan, less than 0.3 wt. % mannan, less than 5 wt. % glucan, and less than 0.1 wt. % arabinan.

The hemicellulose compositions may comprise low amounts of residual xylose, e.g., less than 1 wt. %, less than 0.5 wt. %, or less than 0.1 wt. %. The hemicellulose compositions may also comprise low amounts of lignin, e.g., less than 1 wt. %, less than 0.5 wt. %, or less than 0.1 wt. %. Without being bound by theory, the low residual xylose content may be due to the low water content of the hemicellulose compositions.

The present invention also relates to processes for producing hemicellulose compositions. In one embodiment, the process comprises separating, e.g., extracting, hemicellulose and other cellulosic impurities (e.g., dichloromethane (DCM) extractables and degraded cellulose) from a cellulosic material with an extractant to form an intermediate cellulosic material having a reduced hemicellulose content; concentrating the intermediate cellulosic material to form a concentrated cellulosic material having an increased solids content; and recovering the separated hemicellulose. The extractant used in the separating step comprises a cellulose solvent and a cellulose co-solvent. The cellulose solvent should be suitable for dissolving hemicellulose, and preferably degraded cellulose and other impurities in the cellulosic material, and in combination with a co-solvent, should have little solubility for α-cellulose. The cellulose solvent is selected from the group consisting of an ionic liquid, an amine oxide and combinations thereof, and the cellulose co-solvent is preferably selected from the group consisting of dimethyl sulfoxide (“DMSO”), tetramethylene sulfone, tetramethylene sulfoxide, N-methyl pyrrolidone, dimethyl formamide (“DMF”), acetonitrile, acetic acid, water, and mixtures thereof. The concentrated cellulosic material may be dried to form a finished cellulosic product.

The processes of the invention are particularly suitable for separating and removing impurities, such as hemicellulose and/or degraded cellulose, from a cellulosic material to form a finished cellulosic product, the purity of which may vary widely depending largely on the composition of the starting cellulosic material, the composition of the extractant used, and extraction conditions. In preferred aspects, the finished cellulose product comprises acetate (or higher) grade cellulose and the finished hemicellulose product comprises from 55 to 99 wt. % xylan.

### II. Hemicellulose Compositions

As described herein, the present invention relates to hemicellulose compositions that are distinct from known and/or commercially available hemicellulose compositions. In some embodiments, the hemicellulose composition may comprise at least 55 wt. % xylan, based on carbohydrate analysis of the oven-dried sample weight, e.g., at least 60 wt. %, at least 65 wt. %, or at least 70 wt. %. In terms of ranges, the hemicellulose composition may comprise from 55 to 99 wt. % xylan, e.g., from 55 to 80 wt. %, from 60 to 80 wt. %, from 65 to 75 wt. %, or from 70 to 80 wt. %.

Although xylan is present in the largest amount, on a weight basis, the hemicellulose compositions may further comprise one or more of arabinan, galactan, glucan and/or mannan, generally in amounts totaling less than 20 wt. %, e.g., less than 10 wt. % or less than 5 wt. %. The hemicellulose compositions may comprise less than 0.1 wt. % arabinan, e.g., less than 0.075 wt. %, or less than 0.05 wt. %. In terms of ranges, the hemicellulose compositions may comprise from 0.01 to 0.1 wt. % arabinan, e.g., from 0.01 to 0.075 wt. % or from 0.01 to 0.05 wt. %. The hemicellulose compositions may comprise less than 1 wt. % galactan, e.g., less than 0.5 wt. %, or less than 0.3 wt. %. In terms of ranges, the hemicellulose compositions may comprise from 0.01 to 1 wt. % galactan, e.g., from 0.05 to 0.5 wt. % or from 0.05 to 0.3 wt. %. The hemicellulose compositions may comprise less than 5 wt. % glucan, e.g., less than 4 wt. %, less than 3 wt. %, less than 2 wt. % or less than 1.5 wt. %. In terms of ranges, the hemicellulose compositions may comprise from 0.1 to 5 wt. % glucan, e.g., from 0.5 to 3 wt. % or from 0.75 to 2 wt. %. The hemicellulose compositions may have less than 5 wt. % mannan, e.g., less than 4 wt. % or less than 2 wt. %. In terms of ranges, the hemicellulose compositions may comprise from 0.01 to 5 wt. % mannan, e.g., from 0.01 to 4 wt. % or from 0.01 to 2 wt. %. In some aspects, the hemicellulose composition comprises from 55 to 80 wt. % xylan, less than 5 wt. % mannan, e.g., less than 4 wt. % mannan, less than 5 wt. % glucan and less than 0.1 wt. % arabinan.

In some embodiments, the weight ratio of xylan to mannan is at least 200:1, e.g., at least 500:1 or at least 700:1. In terms of ranges, the weight ratio of xylan to mannan may range from 200:1 to 2000:1, e.g., from 500:1 to 1000:1 or from 600:1 to 800:1.

Although weight percentages of the polysaccharides in hemicellulose are reported, i.e., xylan, arabinan, galactan, glucan and mannan, these weight percentages may be converted to determine the weight percent of the corresponding monosaccharide. For example, the xylan content in the sample may be calculated from the xylose content of carbohydrate analysis by multiplying by a factor of 0.88, and glucan or mannan content may be determined by multiplying by a factor of 0.9. However, as described herein, the hemicellulose compositions comprise low amounts of xylose, e.g., less than 1 wt. %, less than 0.5 wt. % or less than 0.1 wt. %, if any.

The hemicellulose compositions may have a weight-average molecular weight from 20,000 to 35,000 g/mol, e.g., from 22,500 to 30,000 g/mol or from 25,000 to 30,000 g/mol. The hemicellulose compositions may have a number-average molecular weight from 10,000 to 40,000 g/mol, e.g., from 15,000 to 25,000 g/mol or from 20,000 to 25,000 g/mol. The hemicellulose compositions may have a Z-average molecular weight from 20,000 to 45,000 g/mol, e.g., from 30,000 to 45,000 g/mol, or from 40,000 to 45,000 g/mol. The hemicellulose compositions may have a peak molecular weight from 20,000 to 35,000 g/mol, e.g., from 22,500 to 30,000 g/mol or from 25,000 to 30,000 g/mol. The polydispersity index of the hemicellulose compositions, calculated by dividing the weight-average molecular weight by the number-average molecular weight, may range from 1 to 3, e.g., from 1 to 2 or from 1 to 1.5. The hemicellulose compositions may have an intrinsic viscosity of at least 0.3 dL/g, e.g., at least 0.34 dL/g. In terms of ranges, the intrinsic viscosity may range from 0.3 to 0.8 dL/g, e.g., from 0.34 to 0.6 dL/g. The hydrodynamic radius of the hemicellulose compositions may range from 5 to 6 nm, e.g., from 5.1 to 5.5 nm, or from 5.1 to 5.2 nm in a 0.5% lithium chloride (LiCl₂)/DMAc solvent system.

Elemental metals and non-metals may be present in the hemicellulose compositions, including but not limited to silver, tin, bismuth, aluminum, arsenic, boron, barium, beryllium, cadmium, calcium, cobalt, chromium, copper, iron, potassium, magnesium, manganese, molybdenum, sodium, nickel, phosphorous, lead, sulfur, antimony, selenium, titanium, thallium, vanadium, and zinc. The presence and level of elemental metals and non-metals may be controlled by the hemicellulose preparation method. In some aspects, the hemicellulose composition may comprise less than 5000 ppm of Group I metals, e.g., less than 3000 ppm of Group I metals, less than 700 ppm of Group I metals, less than 250 ppm of Group I metals or less than 200 ppm Group I metals. For example, the hemicellulose composition may comprise less than 5000 ppm sodium, e.g., less than 700 ppm sodium, less than 250 ppm sodium or less than 200 ppm sodium. In further aspects, the hemicellulose compositions may comprise less than 5000 ppm potassium, e.g., less than 700 ppm potassium or less than 10 ppm potassium. In some aspects, the total amount of elemental metals and non-metals disclosed herein may be less than 1.5 wt. %, e.g., less than 1 wt. %, or less than 0.6 wt. % (6,000 ppm). In terms of ranges, the total amount of elemental metals and non-metals disclosed herein may range from 500 ppm to 10,000 ppm, e.g., from 750 ppm to 7,500 ppm or from 900 ppm to 6,000 ppm. As used herein, parts per million (ppm) are determined on a weight basis. Without being bound by theory, the sodium and potassium contents of the hemicellulose compositions are low due to the process by which the hemicellulose compositions are prepared, e.g., without caustic treatment.

The hemicellulose compositions are purified compositions that may be derived from hardwood or softwood. Although the hemicellulose compositions may be used in further materials, chemicals or compositions, the inventive hemicellulose compositions are compositions comprised of monosaccharide sugars and elemental metal ions. The hemicellulose compositions comprise at least 98.5 wt. % monosaccharides, on a dried weight basis.

### III. Cellulosic Material

The hemicellulose compositions of the present invention may be formed from natural cellulosic materials, including plant and plant-derived materials. As used herein, the term “cellulosic material” refers to any material comprising cellulose, such as a pulp, and which may contain, for example, α-cellulose, hemicellulose and degraded cellulose. In preferred embodiments, the cellulosic material comprises wood pulp, e.g., paper grade wood pulp. When the cellulosic material is paper grade wood pulp, the processes described herein may be advantageously used to produce hemicellulose compositions and also to produce cellulose compositions, although the processes of the invention are not limited to the use of paper grade wood pulp as the starting cellulosic material.

In some embodiments, the cellulosic material may comprise a cellulosic raw material, which may include, without limitation, plant derived biomass, corn stover, sugar cane stalk, bagasse and cane residues, rice and wheat straw, agricultural grasses, hard wood, hardwood pulp, soft wood, softwood pulp, herbs, recycled paper, waste paper, wood chips, pulp and paper wastes, waste wood, thinned wood, cornstalk, chaff, and other forms of wood, bamboo, soyhull, bast fibers, such as kenaf, hemp, jute and flax, agricultural residual products, agricultural wastes, excretions of livestock, microbial, algal cellulose, and all other materials proximately or ultimately derived from plants. Such cellulosic raw materials are preferably processed in pellet, chip, clip, sheet, attritioned fiber, powder form, or other form rendering them suitable for extraction with the extractant. In some exemplary embodiments, the hemicellulose compositions are derived from hard wood pulps.

Generally, cellulosic material may be derived from lignin-containing materials, where lignin has been removed therefrom. In cellulosic materials, hemicellulose is linked to cellulose by hydrogen bonds. Overall, the cellulose material has a linear shape of fiber morphology, which is surrounded by hemicellulose via hydrogen bonds. These bonds between cellulose and hemicellulose may become weakened by treating the cellulosic material with an extractant to selectively dissolve the hemicellulose while maintaining the fiber morphology of the cellulose material, e.g., leaving the fiber morphology unchanged.

In one embodiment of the invention, the cellulosic material is a paper grade pulp provided in forms such as, but not limited to, rolls, sheets, or bales. Preferably, the paper grade pulp comprises at least 70 wt. % α-cellulose, e.g., at least 80 wt. % α-cellulose or at least 85 wt. % α-cellulose. Paper grade pulp typically also comprises at least 5 wt. % hemicellulose, at least 10 wt. % hemicellulose or at least 15 wt. % hemicellulose. In another embodiment, the cellulosic material may be another α-cellulose containing pulp, such as viscose grade pulp, rayon grade pulp, semi-bleached pulp, unbleached pulp, bleach pulp, kraft pulp, absorbent pulp, dissolving pulp, or fluff. While these cellulosic materials comprise various concentrations of α-cellulose, the inventive processes may advantageously treat them, based on optimized process design, to produce hemicellulose compositions and also to produce higher purity α-cellulose products.

Cellulose is a straight chain polymer and is derived from D-glucose units, which condense through β-1,4-glycosidic bonds. This linkage motif contrasts with that for α-1,4-glycosidic bonds present in starch, glycogen, and other carbohydrates. Unlike starch, there is no coiling or branching in cellulose and cellulose adopts an extended and rather stiff rod-like confirmation, which is aided by the equatorial confirmation of the glucose residues. The multiple hydroxyl groups on the glucose from one chain form hydrogen bonds with oxygen atoms on the same or on a neighboring chain, holding the chains firmly together side-by-side and forming microfibrils with high tensile strength, which then overlay to form the macrostructure of a cellulose fiber. In preferred embodiments of the invention, the finished cellulosic product retains its fiber structure throughout and after the extraction step.

As used herein, the term “hemicellulose” refers to any of several heteropolymers, e.g., polysaccharides, present in plant cell walls. Hemicellulose can include one or more of xylan, glucuronoxylan, arabinoxylan, glucomannan, galactomannan, and xyloglucan. These polysaccharides contain many different sugar monomers and can be hydrolyzed tomonosaccharides, such as xylose, mannose, galactose, rhamnose and arabinose. Xylose is typically the primary sugar present in hard woods and either mannose or xylose is typically the primary sugar present in softwoods.

The processes of the present invention are particularly beneficial in that they are effective for use with paper grade wood pulp that is derived from softwoods and/or from hardwoods. The processes of the present invention provide a technique for recovering a hemicellulose product and for upgrading paper grade pulp produced from hardwood and/or from softwood species.

Softwood species are generally more abundant and faster growing than most hardwood species. Softwood is a generic term typically used in reference to wood from conifers (i.e., needle-bearing trees from the order Pinales). Softwood-producing trees include pine, spruce, cedar, fir, larch, douglas-fir, hemlock, cypress, redwood and yew. Conversely, the term hardwood is typically used in reference to wood from broad-leaved or angiosperm trees. The terms “softwood” and “hardwood” do not necessarily describe the actual hardness of the wood. While, on average, hardwood is of higher density and hardness than softwood, there is considerable variation in actual wood hardness in both groups, and some softwood trees can actually produce wood that is harder than wood from hardwood trees. One feature separating hardwoods from softwoods is the presence of pores, or vessels, in hardwood trees, which are absent in softwood trees. On a microscopic level, softwood contains two types of cells, longitudinal wood fibers (or tracheids) and transverse ray cells. In softwood, water transport within the tree is via the tracheids rather than the pores of hardwoods.

### IV. Extractant

As described above, hemicellulose and optionally degraded cellulose is extracted from the cellulosic material using an extractant. The extractant comprises a cellulose solvent and a co-solvent. The cellulose solvent is selected from the group consisting of an ionic liquid, an amine oxide and mixtures thereof, examples of which are described below. The cellulose solvent may or (more preferably) may not fully dissolve α-cellulose, but preferably dissolves at least hemicellulose and degraded cellulose. α-cellulose preferably is less soluble in the co-solvent than in the cellulose solvent.

a. Ionic Liquid

Ionic liquids are organic salts with low melting points, preferably less than 200° C., less than 150° C., or less than 100° C., many of which are consequently liquid at room temperature. Specific features that make ionic liquids suitable for use in the present invention are their general lack of vapor pressure, their ability to dissolve a wide range of organic compounds and the versatility of their chemical and physical properties. In addition, ionic liquids are non-flammable making them particularly suitable for use in industrial applications. In some embodiments, the cellulose solvent comprises one or more ionic liquids.

It has been found that, in addition to these beneficial properties, when contacted with cellulosic materials, including plant matter and plant matter derivatives, the ionic liquids are capable of acting as a cellulose solvent, dissolving the hemicellulose and cellulose contained therein. In addition, with the appropriate choice of treatment conditions (for example, duration of contact, temperature, and co-solvent composition), ionic liquids penetrate the structure of the cellulose-containing material to break down the material and extract organic species therein. In particular when used in combination with one or more co-solvents, α-cellulosic components remaining in the cellulosic material are preserved and the fiber morphology is advantageously retained.

Ionic liquids, in pure form, generally are comprised of ions and do not necessitate a separate solvent for ion formation. Ionic liquids existing in a liquid phase at room temperature are called room temperature ionic liquids. Generally, ionic liquids are formed of large-sized cations and a smaller-sized anion. Cations of ionic liquids may comprise nitrogen, phosphorous, sulfur, or carbon. Because of the disparity in size between the cation and anion, the lattice energy of the compound is decreased resulting in a less crystalline structure with a low melting point.

Exemplary ionic liquids include the compounds expressed by the following Formula (1):

[A]⁺[B]⁻ (1)

In one embodiment, the ionic liquid is selected from the group consisting of substituted or unsubstituted imidazolium salts, pyridinium salts, ammonium salts, triazolium salts, pyrazolium salt, pyrrolidinium salt, piperidium salt, and phosphonium salts. In preferred embodiments, [A]⁺ is selected from the group consisting of:

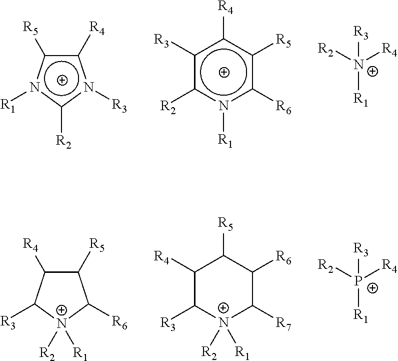

wherein, R₁, R₂, R₃, R₄, R₅, R₆ and R₇ are each independently selected from the group consisting of hydrogen, C₁-C₁₅ alkyls, C₂-C₁₅ aryls, and C₂-C₂₀ alkenes, and the alkyl, aryl or alkene may be substituted by a substituent selected from the group consisting of sulfone, sulfoxide, thioester, ether, amide, hydroxyl and amine. [B]⁻ is preferably selected from the group consisting of Cl⁻, Br⁻, I⁻, OH⁻, NO₃⁻, SO₄²⁻, CF₃CO₂⁻, CF₃SO₃⁻, BF₄⁻, PF₆⁻, CH₃COO⁻, (CF₄SO₂)₂N⁻, AlCl₄⁻, HCOO⁻, CH₃SO₄⁻, (CH₃)₂PO₄⁻, (C₂H₅)₂PO₄⁻ and CH₃HPO₄⁻.

Examples of ionic liquids include tetrabutylammonium hydroxide 30 hydrate (TBAOH.30H₂O), benzyltriethylammonium acetate (BnTEAAc), tetraethylammonium acetate tetrahydrate (TEAAc.4H₂O), benzyltrimethylammonium hydroxide (BnTMAOH), tetramethylammonium hydroxide (TMAOH), ammonium acetate, hydroxyethylammonium acetate, hydroxyethylammonium formate, tetramethylammonium acetate, tetraethylammonium acetate, tetrabutylammonium acetate, tetrabutylammonium hydroxide, 1-butyl-3-methyl imidazolium tetrachloroaluminate, 1-ethyl-3-methyl imidazolium tetrachloroaluminate, 1-ethyl-3-methyl imidalzolium hydrogensulfate, 1-butyl-3-methyl imidazolium hydrogensulfate, methylimidazolium chloride, 1-ethyl-3-methyl imidazolium acetate, 1,3-diethylimidazolium acetate (EEIMAc), 1-butyl-3-methyl imidazolium acetate, tris-2(hydroxyl ethyl)methylammonium methylsulfate, 1-ethyl-3-methyl imidazolium ethylsulfate, 1-ethyl-3-methyl imidazolium methanesulfonate, methyl-tri-n-butylammonium methylsulfate, 1-butyl-3-methyl imidazolium chloride, 1-ethyl-3-methyl imidasolium chloride, 1-ethyl-3-methyl imidazolium thiocyanate, 1-butyl-3-methyl imidazolium thiocyanate, 1-aryl-3-methyl imidazolium chloride, and mixtures or complexes thereof, but the disclosed concept of utilizing ionic liquids is not limited to the disclosed species.

In some embodiments, the ionic liquid is selected from the group consisting of ammonium-based ionic substances, imidazolium-based ionic substances, phosphonium-based ionic substances, and mixtures thereof. The ammonium-based ionic liquid may be selected from the group consisting of ammonium acetate, hydroxyethylammonium acetate, hydroxyethylammonium formate, tetramethylammonium acetate, tetrabutylammonium acetate, tetraethylammonium acetate, benzyltriethylammonium acetate, benzyltributyl ammonium acetate and combinations thereof. The imidazolium-based ionic liquid may be selected from the group consisting of 1-butyl-3-methyl imidazolium tetrachloroaluminate, 1-ethyl-3-methyl imidazolium tetrachloroaluminate, 1-ethyl-3-methyl imidalzolium hydrogensulfate, 1-butyl-3-methyl imidazolium hydrogensulfate, methylimidazolium chloride, 1-ethyl-3-methyl imidazolium acetate, 1,3-diethylimidazolium acetate (EEIMAc), 1-butyl-3-methyl imidazolium acetate, tris-2(hydroxyl ethyl)methylammonium methylsulfate, 1-ethyl-3-methyl imidazolium ethylsulfate, 1-ethyl-3-methyl imidazolium methanesulfonate, methyl-tri-n-butylammonium methylsulfate, 1-butyl-3-methyl imidazolium chloride, 1-ethyl-3-methyl imidasolium chloride, 1-ethyl-3-methyl imidazolium thiocyanate, 1-butyl-3-methyl imidazolium thiocyanate, 1-aryl-3-methyl imidazolium chloride, 1-ethyl-3-methylimidazolium dimethyl phosphate, 1-ethyl-3-methyl diethyl phosphate (EMIMDEP), 1,3-dimethylimidazolium dimethyl phosphate (DMIMDMP) and mixtures or complexes thereof. The ionic liquid may also be selected from the group consisting of N,N-dimethylpyrrolidinium acetate, N,N-dimethylpiperidinium acetate, N,N-dimethylpyrrolidinium dimethyl phosphate, N,N-dimethylpiperidinium dimethyl phosphate, N,N-dimethylpyrrolidinium chloride, N,N-dimethylpiperidinium chloride, and combinations thereof.

In still other embodiments, the ionic liquid may be selected from the group consisting of 1-butyl-3-methylimidazolium tetrachloroaluminate, 1-ethyl-3-methyl imidazolium tetrachloroaluminate, 1-ethyl-3-methyl imidalzolium hydrogensulfate, 1-butyl-3-methyl imidazolium hydrogensulfate, methylimidazolium chloride, 1-ethyl-3-methyl imidazolium acetate, 1-butyl-3-methyl imidazolium acetate, tris-2(hydroxyl ethyl)methylammonium methylsulfate, 1-ethyl-3-methyl imidazolium ethylsulfate, 1-ethyl-3-methyl imidazolium methanesulfonate, methyl-tri-n-butylammonium methylsulfate, 1-butyl-3-methyl imidazolium chloride, 1-ethyl-3-methyl imidasolium chloride, 1-ethyl-3-methyl imidazolium thiocyanate, 1-butyl-3-methyl imidazolium thiocyanate, 1-aryl-3-methyl imidazolium chloride, 1-ethyl-3-methylimidazolium dimethyl phosphate, 1-ethyl-3-methyl diethyl phosphate, 1,3-dimethylimidazolium dimethyl phosphate and combinations and complexes thereof.

In further embodiments, the ionic liquid may be selected from the group consisting of ethyltributylphosphonium diethylphosphate, methyltributylphosphonium dimethylphosphate, tetrabutylphosphonium bromide, tetrabutylphosphonium chloride, tributylmethylphosphonium methylsulfate, trihexyltetradecylphosphonium decanoate, trihexyltetradecylphosphonium dicyanamide, ethyltriphenylphosphonium acetate, ethyltributylphosphonium acetate, benzyltriethylphosphonium acetate, benzyltributylphosphonium acetate, tetrabutylphosphonium acetate, tetraethylphosphonium acetate, tetramethylphosphonium acetate, and combinations thereof.

The ionic liquid may be commercially available, and may include Basionic™ AC 01, Basionic™ AC 09, Basionic™ AC 25, Basionic™ AC 28, Basionic™ AC 75, Basionic™ BC 01, Basionic™ BC 02, Basionic™ FS 01, Basionic™ LQ 01, Basionic™ ST 35, Basionic™ ST 62, Basionic™ ST 70, Basionic™ ST 80, Basionic™ VS 01, and Basionic™ VS 02, but the invention is not limited to use of these species.

In preferred embodiments, the ionic liquid compound, as shown below, may be 1-ethyl-3-methyl imidazolium acetate (EMIMAc) of the structural formula (2), 1-butyl-3-methyl imidazolium acetate (BMIMAc) of the structural formula (3), 1-ethyl-3-methyl imidazolium dimethylphosphate of structural formula (4), 1-ethyl-3-methyl imidazolium formate of the structural formula (5), tetrabutylammonium acetate (TBAAc) of the structural formula (6), 1-allyl-3-methyl imidazolium chloride of the structural formula (7), or 1-n-butyl-3-methyl imidazolium chloride of the structural formula (8):

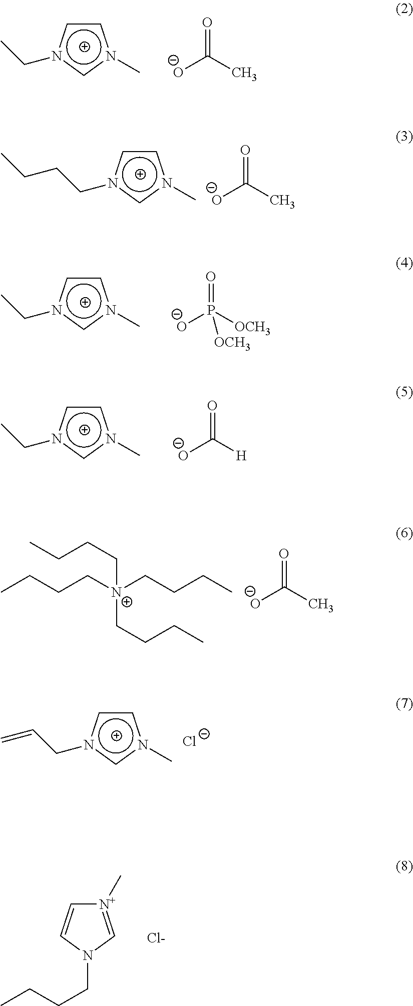

b. Amine Oxide

Amine oxides are chemical compounds that contain the functional group R₃N⁺—O⁻, which represents an N—O bond with three additional hydrogen and/or hydrocarbon side chains. Amine oxides are also known as tertiary amines, N-oxides, amine-N-oxide and tertiary amine N-oxides. In one embodiment, amine oxides that are stable in water may be used.

In some embodiments, the amine oxide may be selected from the group consisting of compounds with chemical structure of acyclic R₃N⁺—O⁻, compounds with chemical structure of N-heterocyclic compound N-oxide, and combinations thereof. In further embodiments, the amine oxide may be an acyclic amine oxide compound with structure of R₁R₂R₃N⁺—O⁻, wherein R₁, R₂ and R₃ are alkyl or aryl chains, the same or different, with chain length from 1 to 18, e.g. trimethylamine N-oxide, triethylamine N-oxide, tripropylamine, N-oxide, tributylamine N-oxide, methyldiethylamine N-oxide, dimethylethylamine N-oxide, methyldipropylamine N-oxide, tribenzylamine N-Oxide, benzyldimethylamine N-oxide, benzyldiethylamine N-oxide, dibenzylmethylamine N-oxide, monomethyldiethylamine, dimethylmonoethylamine, monomethyldipropylamine, N-dimethyl-, N-diethyl- or N-dipropylcyclohexylamine, N-dimethylmethylcyclohexylamine, pyridine, and pyridine N-oxide.

In some embodiments, the amine oxide may be a cyclic amine oxide compound including the structures such as pyridine, pyrrole, piperidine, pyrrolidine and other N-heterocyclic compounds, e.g. N-methylmorpholine N-oxide (NMMO), pyridine N-oxide, 2-, 3-, or 4-picoline N-oxide, N-methylpiperidine N-oxide, N-ethylpiperidine N-oxide N-propylpiperidine N-oxide, N-isopropylpiperidine N-oxide. N-butylpiperidine N-oxide, N-hexylpiperidine N-oxide. N-methylpyrrolidine N-oxide, N-ethylpyrrolidine N-oxide N-propylpyrrolidine N-oxide, N-isopropylpyrrolidine N-oxide. N-butylpyrrolidine N-oxide, N-hexylpyrrolidine N-oxide. In some embodiments, the amine oxide may be the combination of the above mentioned acyclic and/or cyclic amine oxides.

In specific embodiments, the amine oxide may be selected from the group consisting of trimethylamine N-oxide, triethylamine N-oxide, tripropylamine N-oxide, tributylamine N-oxide, methyldiethylamine N-oxide, dimethylethylamine N-oxide, methyldipropylamine N-oxide, tribenzylamine N-Oxide, benzyldimethylamine N-oxide, benzyldiethylamine N-oxide, dibenzylmethylamine N-oxide, N-methylmorpholine N-oxide (NMMO), pyridine N-oxide, 2-, 3-, or 4-picoline N-oxide, N-methylpiperidine N-oxide, N-ethylpiperidine N-oxide N-propylpiperidine N-oxide, N-isopropylpiperidine N-oxide. N-butylpiperidine N-oxide, N-hexylpiperidine N-oxide. N-methylpyrrolidine N-oxide, N-ethylpyrrolidine N-oxide N-propylpyrrolidine N-oxide, N-isopropylpyrrolidine N-oxide. N-butylpyrrolidine N-oxide, N-hexylpyrrolidine N-oxide, and combinations thereof.

Cellulose is insoluble in most solvents because of its strong and highly structured intermolecular hydrogen bonding network. Without being bound by theory, NMMO is able to break the hydrogen bonding network that keeps cellulose insoluble in most solvents. Therefore, the use of NMMO alone would destroy the fiber morphology of cellulose. It has now been discovered that by using the proper ratio of an amine oxide, such as NMMO, with a co-solvent, α-cellulosic components in the cellulosic material may be beneficially preserved and the fiber morphology retained. NMMO is typically stored in 50 to 70 vol. %, e.g., 60 vol. %, aqueous solution as pure NMMO tends toward oxygen separation. See, e.g., U.S. Pat. No. 4,748,241, the entirety of which is incorporated herein by reference. Further contaminants in commercial NMMO product, e.g., N-methylmorpholine, peroxides, and acid components, tend to degrade the storage stability. In other words, further application of NMMO needs to address all stability concerns. For example, developed stabilizers like propyl gallate may be added.

c. Co-Solvent

As stated above, the extractant also comprises a co-solvent. Co-solvents in the context of this invention include solvents that do not have the ability to readily dissolve α-cellulose. In exemplary embodiments, the co-solvent is selected, with various concentrations, from the group consisting of water, acetic acid, alcohols such as methanol, ethanol, n-propanol, isopropanol, n-butanol, tert-butanol, diols and polyols such as ethanediol and propanediol, amino alcohols such as ethanolamine, diethanolamine and triethanolamine, aromatic solvents, e.g., benzene, toluene, ethylbenzene or xylenes, halogenated solvents, e.g. dichloromethane, chloroform, carbon tetrachloride, dichloroethane or chlorobenzene, aliphatic solvents, e.g. pentane, hexane, heptane, octane, ligroin, petroleum ether, cyclohexane and decalin, ethers, e.g. tetrahydrofuran, diethyl ether, methyl tert-butyl ether and diethylene glycol monomethyl ether, ketones such as acetone and methyl ethyl ketone, esters, e.g. ethyl acetate, dimethyl carbonate, dipropyl carbonate, propylene carbonate, amides, e.g., formamide, dimethylformamide (DMF), N,N-dimethylacetamide (DMAC), DMSO, acetonitrile and mixtures thereof. Since the boiling points of co-solvents vary significantly, the efficient purification processes associated with each co-solvent may not be exactly the same.

In one embodiment, a second co-solvent may be used in conjunction with the first co-solvent and the cellulose solvent, e.g., amine oxide or ionic liquid, as described above. In one embodiment, the second co-solvent decreases the viscosity of the extractant. The second co-solvent may have a viscosity, for example, of less than 2.0 mPa·s, e.g., less than 1.8 mPa·s or less than 1.5 mPa·s at 25° C. In some embodiments, the second co-solvent is selected from the group consisting of formamide, DMF, dimethylacetamide, DMSO, N-methylpyrrolidone, propylene carbonate, acetonitrile and mixtures thereof. It is postulated that using a low viscosity second co-solvent in the extractant, the extraction rate is enhanced and a smaller amount of ionic liquid is needed to extract the hemicellulose in the cellulosic material.

Without being bound by theory, the insolubility of the α-cellulose in the co-solvent and the resulting extractant maintains the cellulose fiber morphology, e.g., leaving the fiber morphology unchanged, while the extractant penetrates the cellulosic material, dissolves and extracts the hemicellulose and preferably degraded cellulose from the cellulosic material. Depending on the specific co-solvent used in the extractant, the weight percentage of the cellulose solvent and the co-solvent in the extractant may vary widely.

d. Extractant Compositions

The specific formulation of the extractant employed may vary widely, depending, for example, on the hemicellulose and degraded cellulose content of the starting cellulosic material, and the processing scheme employed. In one embodiment, the extractant optionally comprises at least 0.1 wt. % amine oxide, e.g., at least 2 wt. % or at least 4 wt. %. In terms of upper limits, the extractant optionally comprises at most 85 wt. % amine oxide, e.g., at most 75 wt. %, or at most 70 wt. % amine oxide. In terms of ranges, the extractant optionally comprises from 0.1 wt. % to 85 wt. % amine oxide, e.g., from 2 wt. % to 75 wt. %, or from 4 wt. % to 70 wt. %. The extractant optionally comprises at least 0.1 wt. % co-solvent, e.g., at least 1 wt. %, or at least 3 wt. % co-solvent. In terms of upper limits, the extractant optionally comprises at most 99.9 wt. %, at most 98 wt. %, or at most 97 wt. % co-solvent. In terms of ranges, the extractant optionally comprises from 0.1 wt. % to 99.9 wt. % co-solvent, e.g., from 1 wt. % to 98 wt. %, or from 3 wt. % to 97 wt. % co-solvent.

In one embodiment, the extractant comprises an aqueous co-solvent, e.g., water, and an amine oxide. For example, the extractant optionally comprises at least 40 wt. % amine oxide, e.g., at least 50 wt. % or at least 60 wt. %. In terms of upper limits, the extractant optionally comprises at most 90 wt. % amine oxide, e.g., at most 85 wt. %, or at most 80 wt. % amine oxide. In terms of ranges, the extractant optionally comprises from 40 wt. % to 90 wt. % amine oxide, e.g., from 50 wt. % to 85 wt. %, or from 60 wt. % to 80 wt. % amine oxide. The extractant optionally comprises at least 1 wt. % aqueous co-solvent, e.g., at least 5 wt. %, or at least 10 wt. % aqueous co-solvent. In terms of upper limits, the extractant optionally comprises at most 50 wt. % aqueous co-solvent, at most 40 wt. %, or at most 30 wt. %. In terms of ranges, the extractant optionally comprises from 1 wt. % to 50 wt. % aqueous co-solvent, e.g., from 5 wt. % to 40 wt. %, or from 10 wt. % to 30 wt. %.

In one embodiment, the extractant comprises an organic co-solvent and an amine oxide. In this aspect, the extractant optionally comprises at least 0.1 wt. % amine oxide, e.g., at least 1 wt. % or at least 2 wt. % amine oxide. In terms of upper limits, the extractant optionally comprises at most 85 wt. % amine oxide, e.g., at most 80 wt. %, or at most 70 wt. %. In terms of ranges, the extractant optionally comprises from 0.1 wt. % to 85 wt. % amine oxide, e.g., from 1 wt. % to 80 wt. %, or from 2 wt. % to 70 wt. %. In this aspect, the extractant optionally comprises at least 15 wt. % organic co-solvent, e.g., at least 20 wt. %, or at least 30 wt. %. In terms of upper limits, the extractant optionally comprises at most 99.9 wt. % organic co-solvent, at most 98 wt. %, or at most 97 wt. %. In terms of ranges, the extractant optionally comprises from 15 wt. % to 99.9 wt. % organic co-solvent, e.g., from 20 wt. % to 98 wt. %, or from 30 wt. % to 97 wt. %. In one embodiment, the organic co-solvent is DMSO.

In one embodiment, the extractant includes an amine oxide, a first co-solvent and a second co-solvent. In one embodiment, the extractant includes an amine oxide, an aqueous co-solvent, e.g., water, and an organic co-solvent, e.g., DMSO. In this aspect, the amine oxide concentration may range, for example, from 1 wt. % to 85 wt. %, the water concentration may range from 1 wt. % to 35 wt. %, and the organic co-solvent, e.g., DMSO, concentration may range from 1 wt. % to 98 wt. %.

In other embodiments, the cellulose solvent used in the extractant comprises one or more ionic liquids. For example, the extractant optionally comprises at least 0.1 wt. % ionic liquid, e.g., at least 1 wt. % or at least 2 wt. %. In terms of upper limits, the extractant optionally comprises at most 95 wt. % ionic liquid, e.g., at most 90 wt. %, or at most 85 wt. %. In terms of ranges, the extractant optionally comprises from 0.1 wt. % to 95 wt. % ionic liquid, e.g., from 1 wt. % to 90 wt. %, or from 2 wt. % to 85 wt. %. The extractant optionally comprises at least 5 wt. % co-solvent, e.g., at least 10 wt. %, at least 15 wt. %, or at least 20 wt. %. In terms of upper limits, the extractant optionally comprises at most 99.9 wt. % co-solvent, at most 99 wt. %, or at most 98 wt. %. In terms of ranges, the extractant optionally comprises from 5 wt. % to 99.9 wt. % co-solvent, e.g., from 10 wt. % to 99 wt. %, or from 20 wt. % to 98 wt. %.

In one embodiment, the cellulose solvent comprises one or more ionic liquids and the co-solvent comprises an aqueous co-solvent, e.g., water. In this aspect, the extractant preferably comprises at least 50 wt. % ionic liquid, e.g., at least 65 wt. % or at least 80 wt. %. In terms of upper limits, the extractant optionally comprises at most 95 wt. % ionic liquid, e.g., at most 90 wt. %, or at most 85 wt. %. In terms of ranges, the extractant optionally comprises from 50 wt. % to 95 wt. % ionic liquid, e.g., from 65 wt. % to 90 wt. %, or from 70 wt. % to 85 wt. %. The extractant optionally comprises at least 5 wt. % aqueous co-solvent, e.g., at least 10 wt. %, at least 15 wt. %, or at least 20 wt. %. In terms of upper limits, the extractant optionally comprises at most 50 wt. % aqueous co-solvent, e.g., at most 35 wt. %, or at most 20 wt. % aqueous co-solvent. In terms of ranges, the extractant may comprise from 5 wt. % to 50 wt. % aqueous co-solvent, e.g., from 10 wt. % to 35 wt. %, or from 15 wt. % to 20 wt. %.

In one embodiment, when the extractant comprises one or more ionic liquids as cellulose solvent and an organic co-solvent, the extractant preferably comprises at least 0.1 wt. % ionic liquid, e.g., at least 1 wt. % or at least 2 wt. %. In terms of upper limits, the extractant optionally comprises at most 20 wt. % ionic liquid, e.g., at most 15 wt. %, or at most 10 wt. %. In terms of ranges, the extractant may comprise from 0.1 wt. % to 20 wt. % ionic liquid, e.g., from 1 wt. % to 15 wt. %, or from 2 wt. % to 10 wt. %. The extractant optionally comprises at least 80 wt. % organic co-solvent, e.g., at least 85 wt. %, or at least 90 wt. %. In terms of upper limits, the extractant may comprise at most 99.9 wt. % organic co-solvent, e.g., at most 98 wt. %, or at most 97 wt. %. In terms of ranges, the extractant optionally comprises from 80 wt. % to 99.9 wt. % organic co-solvent, e.g., from 85 wt. % to 98 wt. %, or from 90 wt. % to 97 wt. %. In one embodiment, the organic co-solvent is DMSO.

In one embodiment, the extractant includes a cellulose solvent, e.g., amine oxide or ionic liquid, a first co-solvent and a second co-solvent. In this aspect, the weight ratio of first co-solvent to second co-solvent is preferably from 20:1 to 1:20, e.g. from 15:1 to 1:15 or from 10:1 to 1:10. Since the production costs of ionic liquids are generally higher than those of co-solvents, the use of a large amount of the second co-solvent beneficially reduces the cost of purifying the cellulosic material.

In one embodiment, the extractant includes an ionic liquid, a first co-solvent and a second co-solvent. In one embodiment, the extractant includes an ionic liquid, an aqueous co-solvent, e.g., water, and an organic co-solvent, e.g., DMSO. In the tertiary extractant system, the extractant may include at most 50 wt. % ionic liquid, e.g., at most 40 wt. %, or at most 30 wt. %. In terms of lower limit, the extractant may include at least 0.1 wt. % ionic liquid, e.g., at least 5 wt. % or at least 10 wt. %. In terms of ranges, the extractant may include from 0.1 wt. % to 50 wt. % ionic liquid, e.g., from 5 wt. % to 40 wt. %, or from 10 wt. % to 30 wt. %. In some embodiments, the extractant may include at most 20 wt. % the first co-solvent, i.e., at most 16 wt. %, or 10 wt. %. In terms of ranges the extractant may include from 0.5 wt. % to 20 wt. % the first co-solvent, e.g., from 3 wt. % to 16 wt. % or from 5 wt. % to 10 wt. %. In one embodiment, water is the first co-solvent. In one embodiment, DMSO is the second co-solvent. Without being bound by theory, it is postulated that the decrease in viscosity in the extractant by using the second co-solvent beneficially enhances the extraction rate and increases the amount of hemicellulose extracted from the cellulosic material.

In one embodiment, the extractant comprises an aqueous co-solvent, an ionic liquid and an amine oxide. In this aspect, the co-solvent concentration may range, for example, from 5 wt. % to 50 wt. %, the ionic liquid concentration may range from 0.1 wt. % to 50 wt. %, and the amine oxide concentration may range from 0.1 wt. % to 85 wt. %.

In one embodiment, the extractant comprises an organic co-solvent, an ionic liquid and an amine oxide. In this aspect, the co-solvent concentration may, for example, range from 5 wt. % to 99 wt. %, the ionic liquid concentration may range from 0.1 wt. % to 50 wt. %, and the amine oxide concentration may range from 0.1 wt. % to 50 wt. %.

### V. Process for Forming a Hemicellulose Composition

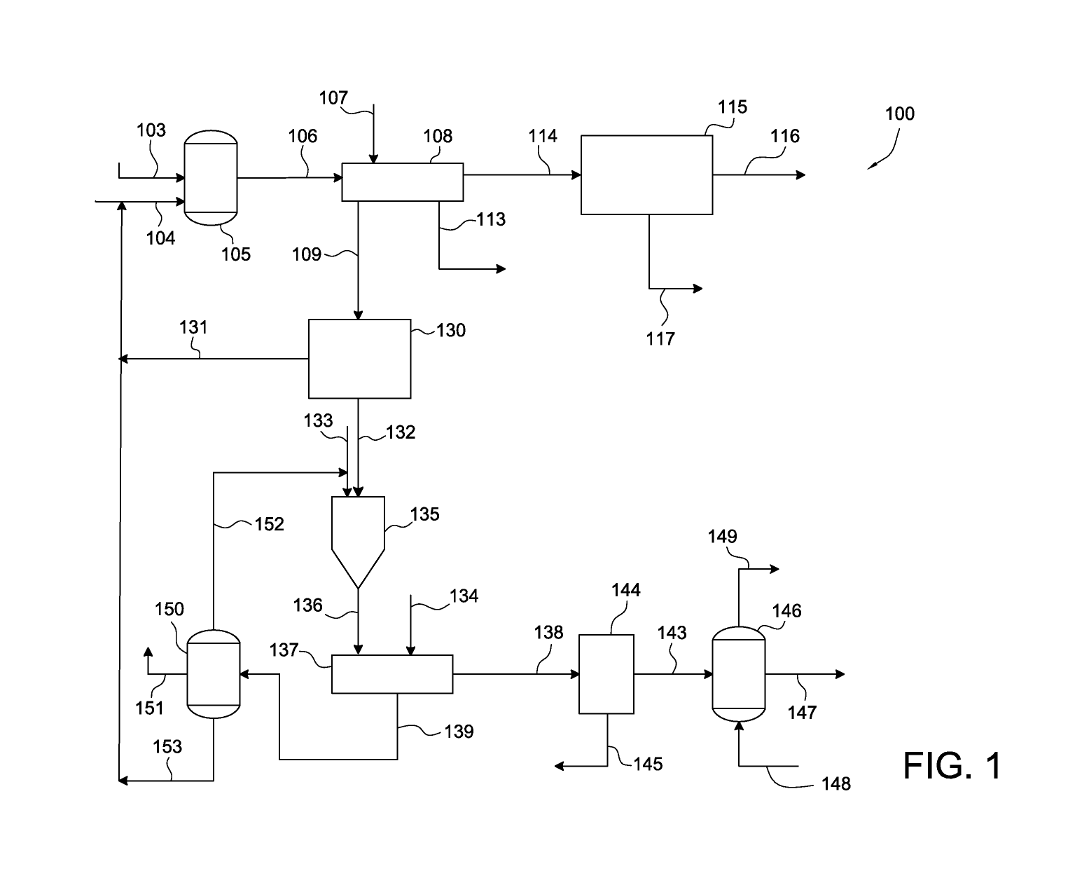

As described herein, cellulosic material may be purified through an inventive extraction process that extracts and recovers hemicellulose from a cellulosic material. FIG. 1 illustrates one non-limiting exemplary system for purifying a cellulosic material, and recovering a hemicellulose composition. As shown in FIG. 1, the cellulosic material may be purified in purification process 100. As shown, the cellulosic material is fed via line 103 to extractor 105. Line 103 may represent, for example, a pneumatic lock hopper, a screw feeder, a belt feeder, a rotary valve feeder, or another type of solid transport equipment. Extractant, comprising a cellulose solvent and co-solvent, as described above, is fed to extractor 105 via line 104. Although cellulosic material 103 and extractant 104 are shown as fed separately to extractor 105, it is contemplated that they may be completely or partially mixed prior to being fed to extractor 105. As shown in FIG. 1, cellulosic material 103 and extractant 104 may be combined in extractor 105 to form an extraction mixture. The extraction mixture within extractor 105 may comprise, for example, from 0.1 to 20 wt. % solids, e.g., from 0.5 to 15 wt. % or from 1.25 to 10 wt. % solids.

Extractant 104 for extracting cellulosic material 103 may be any extractant capable of dissolving preferably at least 50% of the hemicellulose, more preferably at least 75% or at least 90% of the hemicellulose, in cellulosic material 103, as determined by UV absorbance analysis of hemicellulose concentration for hardwood and mass measurements of the feed, cellulosic product, and hemicellulose product. Extractant 104 comprises a cellulose solvent and co-solvent in relative amounts that do not overly degrade or dissolve the cellulose. For example, in one embodiment, the extractant dissolves less than 15% of the α-cellulose in cellulosic material 103, e.g., less than 10%, or less than 5%, as determined similarly by UV absorbance analysis and mass measurements.

As described above, amine oxides and ionic liquids may tend to dissolve α-cellulose. The extractant preferably comprises sufficient co-solvent to reduce α-cellulose solubility in the overall extractant to a point that the α-cellulose does not readily dissolve therein. Preferably, the α-cellulose is substantially insoluble in the co-solvent. Extractant 104 in accordance with the present invention, therefore, has the property of selectively dissolving the hemicellulose and preferably degraded cellulose that is in cellulosic material 103.

Exemplary compositions for the cellulosic material and extractant fed to the extractor, and for the resulting extraction mixture are provided in Table 1.

TABLE 1
EXTRACTOR 105

| | | |
|---|---|---|
| Conc. (wt. %) | Conc. (wt. %) | Conc. (wt. %) |

Cellulosic Material 103

| | | | |
|---|---|---|---|
| “Cellulose”* | 50 to 90 | 55 to 85 | 60 to 80 |
| “Hemicellulose”** | 1 to 40 | 5 to 30 | 10 to 25 |
| Water | 0.1 to 49 | 1 to 39 | 1 to 29 |

Extractant 104

| | | | |
|---|---|---|---|
| Solvent | 0.1 to 99.9 | 2 to 90 | 3 to 80 |
| Co-solvent | 0.1 to 99.9 | 10 to 98 | 20 to 97 |

Extraction Mixture in Extractor 105

| | | | |
|---|---|---|---|
| Cellulose | 0.3 to 14 | 0.3 to 13 | 0.3 to 12 |
| Hemicellulose*** | 0.005 to 6 | 0.03 to 5 | 0.05 to 4 |
| Water | 0.001 to 3 | 0.005 to 3 | 0.005 to 2 |
| Solvent | 0.09 to 99.4 | 1.7 to 90 | 2.6 to 80 |
| Co-solvent | 0.09 to 99.4 | 8.5 to 98 | 17 to 97 |

*“Cellulose” refers to cellulose of all forms including degraded cellulose
**“Hemicellulose” in cellulosic material 103 refers to hemicellulose alone excluding non-hemicellulose impurities
***“Hemicellulose” after being dissolved in extractant 104 refers to hemicellulose, degraded cellulose, and other impurities

The treatment of cellulosic material 103 with extractant 104 may be conducted at an elevated temperature, and preferably occurs at atmospheric pressure or slightly above atmospheric pressure. Preferably, the contacting is conducted at a temperature from 30° C. to 300° C., e.g., from 40° C. to 200° C., or from 50° C. to 150° C. In terms of upper limits, the treatment of cellulosic material 103 may be conducted at a temperature of less than 300° C., e.g., less than 200° C., or less than 150° C. In terms of lower limit, the treatment of cellulosic material 103 may be conducted at a temperature of greater than 30° C., e.g., greater than 40° C., or greater than 50° C. The pressure (absolute, unless otherwise indicated) is in the range from 100 kPa to 10 MPa, preferably from 100 kPa to 5000 kPa, more preferably from 100 kPa to 1100 kPa. In some embodiments, the pressure may be reduced below 100 kPa, e.g., from 1 to 99 kPa.

Cellulosic material 103 may contact extractant 104 (or have a residence time in extractor 105 for continuous processes) between 5 minutes to 1000 minutes, e.g., between 20 minutes to 500 minutes, or from 40 minutes to 200 minutes. In terms of lower limits, the treatment of cellulosic material 103 may be for at least 5 minutes, e.g., at least 20 minutes or at least 40 minutes. In terms of upper limits, the treatment of cellulosic material 103 may be for at most 1000 minutes, e.g., at most 500 minutes, or at most 200 minutes.

The extraction process may be conducted in a batch, a semi-batch or a continuous process with material flowing either co-current or counter-current in relation to one another. In a continuous process, cellulosic material 103 contacts extractant 104 in one or more extraction vessels. In one embodiment, extractant 104 may be heated to the desired temperature before contacting cellulosic material 103. In one embodiment, the extraction vessel(s) may be heated by any suitable means to the desired temperature. Additionally, an inert gas (not shown), e.g., nitrogen or CO₂, may be supplied to the extractor to improve turbulence in the extractor and thus improving heat and mass transfers. The flow rate of inert gas will be controlled not to cause hydrodynamic problem, e.g. flooding. When the size and concentration of solid materials along with the flow rate of inert gas are well controlled, the addition of an inert gas may cause the solids in extractor 105 to float on the surface of the extraction mixture allowing for the solids to be skimmed off the surface of the liquid phase contained in extractor 105.

In the extraction step, the mass ratio of extractant to cellulosic material may range from 5:1 to 500:1, e.g., from 7:1 to 300:1, or from 10:1 to 100:1. The solid:liquid volume ratio may range from 0.005:1 to 0.17:1, e.g., from 0.01:1 to 0.15:1 or from 0.02:1 to 0.1:1, depending on the extraction apparatus and set-up. In one embodiment, a solid:liquid ratio of from 0.01:1 to 0.02:1 or about 0.0125:1 may be used to facilitate the filtration operation in a batch process. In another embodiment, a solid:liquid ratio of 0.1:1 to 0.17:1 can be used, in particular for extractors employing countercurrent extraction. The amount of extractant employed has a significant impact on process economics. Counter-current extraction may achieve greater extraction efficiency while maintaining reasonable extractant usage. Counter-current extraction of solubles from pulp can be accomplished in a variety of commercial equipment such as, but not limited to, a series of agitated tanks, hydrapulpers, continuous belt extractors, and screw extractors. Twin-screw extractors are generally more efficient than single-screw extractors. After extraction, the separation of solid and liquid phases can be completed in suitable commercial equipment, which includes filters, centrifuges, and the like.

In one embodiment, the cellulosic material is subjected to repeated extraction steps. For example, the cellulosic material may be treated with the extractant in an initial extraction step followed by one or more additional extraction steps, in the same or multiple extractors, to further extract residual hemicellulose and/or degraded cellulose. In one embodiment, the cellulosic product may be subjected to an initial extraction step, followed by an extractant wash step, followed by a second extraction step. In some embodiments, the cellulosic product may be subjected to a third or fourth extraction step. When multiple extraction steps are employed, the extractant in each extraction step may be the same or varied to account for the different concentrations of hemicellulose and degraded cellulose in intermediate cellulosic materials between extraction steps. For example, a first extraction may use an extractant comprising an ionic liquid and a co-solvent and a second extraction may use an extractant comprising an amine oxide and a co-solvent, or vice versa, optionally with one or more extractant wash steps between and/or after the second extraction step. Similar configurations can be designed and optimized based upon the general chemical engineering principles and process design theory.

In another embodiment (not shown), the process may further include enzymatic digestion of hemicellulose, extraction and/or isolation of digested hemicellulose and recovery of a cellulosic product with reduced hemicellulose content. Without being bound by theory, by treating the cellulosic material first with the extractant, enzymes may be better able to penetrate the cellulosic material to hydrolyze residual hemicellulose and/or degraded cellulose contained therein. In contrast, experimental data has shown that less hemicellulose may be removed from the cellulosic material if it is first treated with an enzyme cocktail under optimum enzyme hydrolysis conditions, followed by an extraction step. For enzymes to be effective in hydrolyzing hemicellulose, a pretreatment step (e.g., prehydrolysis) is preferred in order to make the cellulosic materials amenable to enzymatic hydrolysis. The pretreatment step preferably comprises treating the cellulosic material with high pressure steam, optionally at low or high acid concentrations, or ammonia treatment. Some modification to the process flow scheme may be desired since the enzyme treatment would likely necessitate increased residence time to complete enzymatic hydrolysis. In addition, acidity (pH), temperature and ionic strength would likely need to be adjusted for effective enzymatic treatment.

In this embodiment, after the extraction step, the cellulosic material may be treated with an enzyme, preferably a hemicellulase, to break down residual hemicellulose contained in the cellulosic material. The hemicellulase includes one or more enzymes that hydrolyze hemicellulose to form simpler sugars, ultimately yielding monosaccharides, such as glucose, hexoses and pentoses. Suitable hemicellulase include one or more of xyloglucanase, β-xylosidase, endoxylanase, α-L-arabinofuranosidase, α-glucuronidase, mannanase, and acetyl xylan esterase. Preferably, the enzymes include a combination of both endo-enzymes (i.e., enzymes hydrolyzing internal polysaccharide bonds to form smaller poly- and oligosaccharides) and exo-enzymes (i.e., enzymes hydrolyzing terminal and/or near-terminal polysaccharide bonds) to facilitate the rapid hydrolysis of large polysaccharide molecules. Suitable commercial hemicellulase include SHEARZYME (available from Novozymes A/S, Bagsvaerd, Denmark), PULPZYME (available from Novozymes A/S, Bagsvaerd, Denmark), FRIMASE B210 (available from Puratos, Groot-Bijgaarden, Belgium), FRIMASE B218 (available from Puratos, Groot-Bijgaarden, Belgium), GRINDAMYL (available from Danisco, Copenhagen, Denmark), ECOPULP TX200A (available from AB Enzymes, Darmstadt, Germany), MULTIFECT Xylanase (available from Genencor/Danisco, Palo Alto, USA), PENTOPAN Mono BG (available from Novozymes, Bagsvaerd, Denmark), and PENTOPAN 500 BG (available from Novozymes, Bagsvaerd, Denmark).

The enzymes generally can be used in amounts that are not particularly limited. For example, hemicellulase can be used in amounts ranging from about 0.001 mg/g to about 500 mg/g (e.g., about 0.05 mg/g to about 200 mg/g, about 0.1 mg/g to about 100 mg/g, about 0.2 mg/g to about 50 mg/g, or about 0.3 mg/g to about 40 mg/g). The concentration units are milligrams of enzyme per gram of cellulosic material to be treated.

After the desired contacting time, an extraction mixture is removed from extractor 105 via line 106. The extraction mixture 106 comprises extractant, dissolved hemicellulose, dissolved degraded cellulose, side products, e.g., mono-, di-, and oligo-saccharide, and an intermediate cellulosic material having reduced hemicellulose content and preferably reduced degraded cellulose content. As shown in FIG. 1, extraction mixture 106 may be fed to filter/washer 108 to remove extractant, dissolved hemicellulose, and dissolved degraded cellulose. Removal of the extractant in the filtering step reduces the amount of residual hemicellulose that must be further processed with the intermediate cellulosic material. It also reduces the amount of extractant that must be separated from the intermediate cellulose in subsequent steps. Filter/washer 108 may comprise solid-liquid separation equipment, including but not limited to, for example, rotary vacuum drums, belt filters and screw presses. Filter/washer 108 forms a washed intermediate cellulosic material 114 and an extraction filtrate 109.

Prior to exiting filter/washer 108, optionally while on a vacuum belt filter, the intermediate cellulosic material may be washed with extractant wash 107 to further reduce the amount of extractant remaining in the filtered extraction mixture. The washing may be conducted in a batch, a semi-batch or a continuous process with material flowing either co-current or counter-current in relation to one another. In some embodiments, the intermediate cellulosic material may be washed more than once in separate washing units from filter/washer 108. When more than one washing step is used, the composition of the extractant wash may vary in the different washing steps. For example, a first washing step may use DMSO as an extractant wash to remove residual hemicellulose and ionic liquid and a second washing step may use water as an extractant wash to remove residual DMSO. A similar configuration can be designed and optimized based upon the general chemical engineering principles and process design theory.

Extractant wash 107 preferably comprises a co-solvent, which dissolves residual hemicellulose and/or degraded cellulose from the cellulosic material, but may also include some low level of extractant resulting from the sequence of washing steps. In one embodiment, the extractant wash is selected from the group consisting of water, acetonitrile, DMF, DMAC, ketones (e.g. acetone), aldehydes, esters (e.g. methyl acetate, ethyl acetate), ethers (e.g., MTBE), lactones, carboxylic acids (e.g., acetic acid), alcohols, polyols, amino alcohols, DMSO, formamide, propylene carbonate, aromatic solvents, halogenated solvents, aliphatic solvents, vinyl acetate, nitriles (propionitrile, chloroacetonitrile, butyonitrile), chloroform, dichloromethane, and mixtures thereof. In another embodiment, extractant wash 107 is selected from the group consisting of DMSO, DMF, N-methyl pyrrolidone, methanol, ethanol, isopropanol, dimethyl carbonate, propylene carbonate, acetone, water, and mixtures thereof. In some embodiments, at least two extractant washes are used in series, such as DMSO and water. It should be understood that, depending on the amount of residual hemicellulose contained in the cellulosic material, the amount of extractant wash may be minimized to reduce capital cost and energy requirements for subsequent separation and recycle, described below. Additionally, it should be understood that the one or more extractant washes may also be used to remove side products, e.g., mono-, di-, and oligo-saccharides from the extraction mixture.

The extractant wash may further comprise one or more washing aids that improve the removal of extractant from the cellulosic material, improve operability, or otherwise improve the physical properties of the intermediate cellulose material. The washing aids may include, for example, defoamers, surfactants, and mixtures therefore. The amount of washing agent can vary widely based upon the amount of residual extractant, quality requirement for cellulosic product, and process operability.

The extractant wash may then be removed via line 113, e.g., as used extractant wash filtrate. The washed intermediate cellulosic material exits filter/washer 108 as an intermediate cellulosic material 114 having reduced hemicellulose content and preferably reduced degraded cellulose content. Intermediate cellulosic material 114 may comprise less than 6 wt. % extractant, e.g., less than 5 wt. % or less than 4 wt. % extractant. In some embodiments, the intermediate cellulosic material 112 may comprise less than 0.5 wt. % cellulose solvent (ionic liquid and/or amine oxide), e.g., less than 0.05 wt. %, less than 0.005 wt. %, or less than 0.001 wt. %. Intermediate cellulosic material 112 may comprise from 9.9 to 99% solids, e.g., from 19 to 90% or from 28 to 85%.

Exemplary compositions using DMSO as the co-solvent and water as the extractant wash for the intermediate cellulosic material are provided in Table 2. When DMSO is used as the co-solvent and water is used as the extractant wash, at least 90% of the cellulose in cellulosic material 103 is maintained in cellulose product 116, as described herein.

TABLE 2
FILTER/WASHER 108

| | | |
|---|---|---|
| Conc. (wt. %) | Conc. (wt. %) | Conc. (wt. %) |

Extraction Mixture 106

| | | | |
|---|---|---|---|
| Cellulose | 0.24 to 14 | 0.26 to 13 | 0.29 to 12 |
| Hemicellulose* | 0.008 to 7 | 0.03 to 5 | 0.05 to 5 |
| Solvent | 0.09 to 99.4 | 1.7 to 90 | 2.6 to 80 |
| (e.g., Ionic Liquid) | | | |
| Co-solvent | 0.09 to 99.4 | 8.5 to 98 | 17 to 97 |
| (e.g., DMSO) | | | |

Washed Intermediate Cellulosic Material 114

| | | | |
|---|---|---|---|
| Cellulose | 9.9 to 99 | 19 to 90 | 28 to 85 |
| Hemicellulose* | 0.003 to 12 | 0.02 to 9 | 0.06 to 7 |
| Extractant wash | 1 to 90 | 10 to 80 | 15 to 70 |
| (e.g., water) | | | |

Extraction Filtrate 109

| | | | |
|---|---|---|---|
| Cellulose | 0.002 to 1.4 | 0.003 to 1.3 | 0.003 to 1.2 |
| Hemicellulose* | 0.008 to 6.7 | 0.03 to 5.2 | 0.05 to 4.4 |
| Solvent | 0.09 to 99.9 | 1.7 to 90 | 2.6 to 80 |
| (e.g., Ionic Liquid) | | | |
| Co-solvent | 0.09 to 99.9 | 8.5 to 99.6 | 17.0 to 99.3 |
| (e.g., DMSO) | | | |

Used Extractant wash (Filtrate) 113

| | | | |
|---|---|---|---|
| Water | 91 to 99.8 | 93 to 99.7 | 94 to 99.7 |
| Solvent | 0.004 to 2.7 | 0.004 to 2.0 | 0.004 to 1.5 |
| (e.g., Ionic Liquid) | | | |
| Co-solvent | 0.01 to 2.7 | 0.02 to 2.2 | 0.03 to 1.9 |
| (e.g., DMSO) | | | |

*“Hemicellulose” in these streams includes hemicellulose, degraded cellulose and other impurities

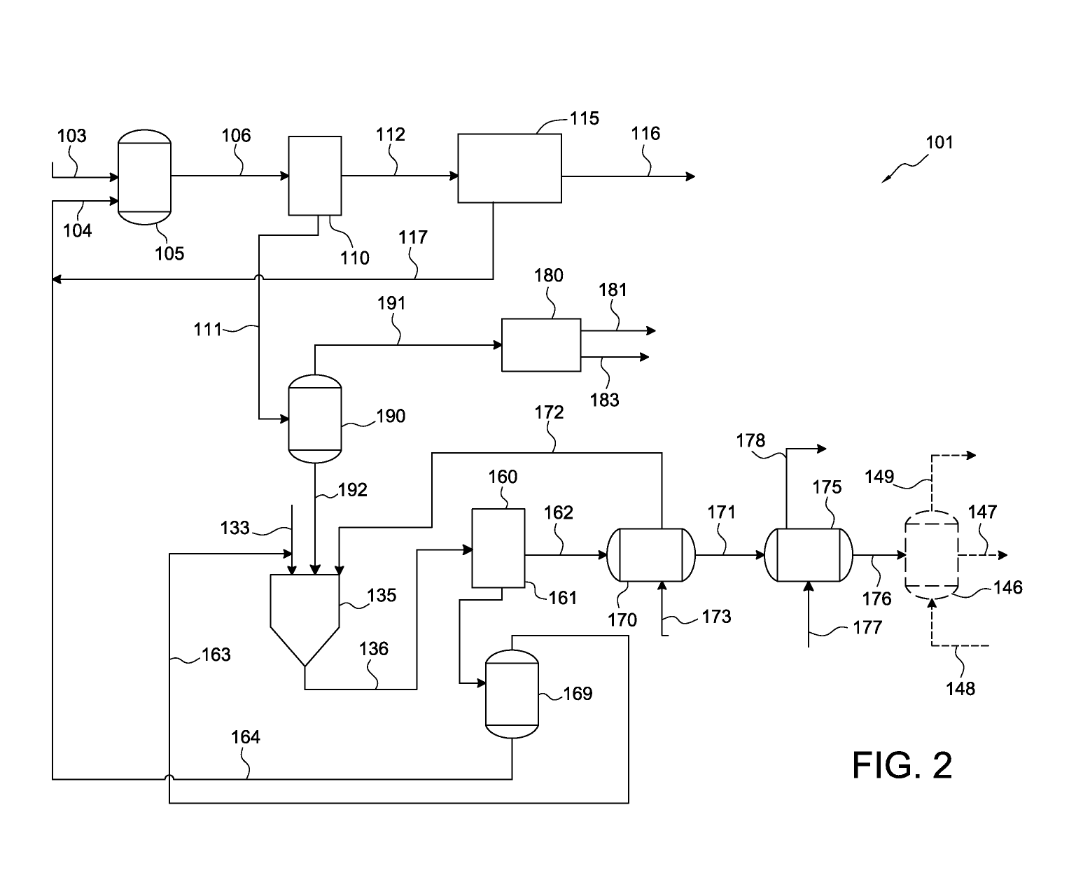

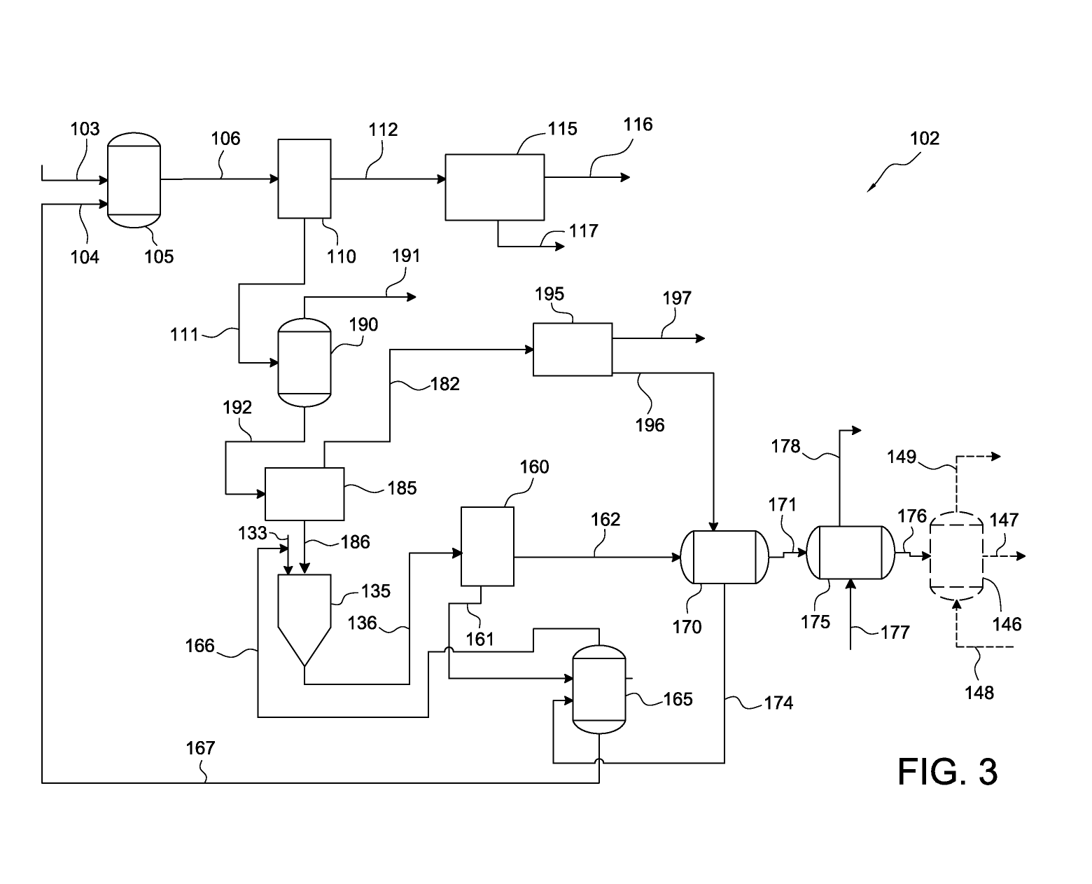

In another aspect, as shown in FIGS. 2 and 3, filter/washer 108 is replaced with filter 110. In this aspect, extraction mixture 106 is sent to filter 110 to form filtered intermediate cellulosic material 112 and extraction filtrate 111. Exemplary compositions using acetonitrile as the co-solvent are provided in Table 3.

TABLE 3
FILTER 110

| | | |
|---|---|---|
| Conc. (wt. %) | Conc. (wt. %) | Conc. (wt. %) |

Extraction Mixture 106

| | | | |
|---|---|---|---|
| Cellulose | 0.2 to 14 | 0.3 to 13 | 0.3 to 12 |
| Hemicellulose*** | 0.008 to 7 | 0.03 to 5 | 0.05 to 4 |
| Water | 0.001 to 10 | 0.01 to 8 | 0.1 to 5 |
| Solvent | 0.09 to 99.4 | 1.7 to 90 | 2.6 to 80 |
| Co-solvent | 0.09 to 99.4 | 8.5 to 98 | 17 to 97 |
| (e.g., Acetonitrile) | | | |

Intermediate Cellulosic Material 112

| | | | |
|---|---|---|---|
| Cellulose | 25 to 80 | 29 to 79 | 33 to 78 |
| Hemicellulose* | 0.003 to 15 | 0.02 to 10 | 0.05 to 8 |
| Solvent | 0.02 to 70 | 0.34 to 63 | 0.51 to 56 |
| (e.g., Ionic Liquid) | | | |
| Co-solvent | 0.02 to 70 | 1.7 to 68 | 3.4 to 68 |
| (e.g., Acetonitrile) | | | |
| Water | 0.0003 to 7 | 0.002 to 6 | 0.02 to 4 |

Extraction Filtrate 111

| | | | |
|---|---|---|---|
| Cellulose | 0.002 to 5.2 | 0.003 to 3.9 | 0.004 to 2.9 |
| Hemicellulose* | 0.01 to 5.6 | 0.05 to 5.5 | 0.07 to 5.4 |
| Solvent | 0.08 to 99.3 | 1.7 to 90 | 2 to 80 |
| (e.g., Ionic Liquid) | | | |
| Co-solvent | 0.08 to 99.3 | 8 to 97.4 | 16 to 96.4 |
| (e.g., Acetonitrile) | | | |

Intermediate cellulosic material 112 or 114 may then be sent to cellulose product purification zone 115 to be further purified by de-liquoring, washing, and/or drying to form cellulose product 116. Impurities, residual extractant and washing agents may be removed from cellulose product purification zone 115 via line 117 and may be recycled within the process as shown in FIG. 2, optionally after further separation and/or purification. Depending on the purity of the starting cellulosic material, high purity α-cellulose product may be produced. In preferred embodiments, the finished cellulose product comprises high purity α-cellulose products such as high purity dissolving grade pulps with less than 5 wt. % hemicellulose, e.g., less than 2 wt. % hemicellulose or less than 1 wt. % hemicellulose. In one embodiment, the cellulosic product has an UV absorbance of less than 2.0 at 277 nm, e.g., less than 1.6 at 277 nm, or less than 1.2 at 277 nm for hardwood species. Paper grade pulp typically has an UV absorbance of greater than 4.7 at 277 nm, as determined by standard UV absorbance measurements. Conveniently and accurately, purity of the α-cellulose product may be indicated by a lower absorbance at a certain wavelength.

In addition to retaining the fiber morphology of the cellulosic product, the high purity α-cellulose grade pulp product also may advantageously retain other beneficial characteristics such as intrinsic viscosity and brightness. The high purity α-cellulose grade pulp product may be further processed to make cellulose derivatives, such as cellulose ether, cellulose esters, cellulose nitrate, other derivatives of cellulose, or regenerated cellulose fiber, such as viscose, lyocell, rayon, etc. Preferably, the high purity α-cellulose grade pulp may be used to make cellulose acetate.

Returning to extractant filtrate 109 as shown in FIG. 1, the stream may be sent to a hemicellulose concentrator 130 to form a (first) recovered extractant 131 and hemicellulose concentrate 132. The recovered extractant 131 will likely be enriched in co-solvent and lean in ionic liquid relative to extractant 104. The hemicellulose concentrator 130 may comprise a filtration unit or an evaporator. The filtration unit may be an ultrafiltration unit or a nanofiltration unit, or membrane separation unit, and may comprise a membrane. The filtration unit may be operated at a pressure from 1 kPa to 5,000 kPa and a temperature from 0° C. to 200° C. and appropriate flow rates. If an evaporator is used, the conditions employed preferably include a pressure from 1 kPa to 1,000 kPa and temperature from 30° C. to 200° C.

Exemplary compositions for the recovered extractant and the hemicellulose concentrate are provided in Table 4.

TABLE 4
HEMICELLULOSE CONCENTRATOR 130

| | | |
|---|---|---|
| Conc. (wt. %) | Conc. (wt. %) | Conc. (wt. %) |

(First) Recovered Extractant 131

| | | | |
|---|---|---|---|
| Solvent | 0 to 5 | 0 to 3 | 0 to 1 |
| (e.g., Ionic Liquid) | | | |
| Co-solvent | 95 to 100 | 97 to 100 | 99 to 100 |
| (e.g., DMSO) | | | |

Hemicellulose Concentrate 132

| | | | |
|---|---|---|---|
| Cellulose | 0.003 to 13.4 | 0.003 to 12.6 | 0.003 to 11.9 |
| Hemicellulose* | 0.008 to 67 | 0.03 to 51 | 0.06 to 44 |
| Solvent | 0.09 to 99.9 | 1.8 to 99 | 2.7 to 98 |
| (e.g., Ionic Liquid) | | | |
| Co-solvent | 0.009 to 99.3 | 0.17 to 96 | 0.26 to 93 |
| (e.g., DMSO) | | | |
| Water | 0.0005 to 3.0 | 0.005 to 2.5 | 0.005 to 1.8 |

*“Hemicellulose” in stream 132 includes hemicellulose, degraded cellulose and other impurities

The recovered extractant 131 may be recycled to the extractor. In some embodiments, recovered extractant 131 may be combined with extractant 104, as shown. In other embodiments, when recovered extractant 131 consists essentially of co-solvent, recovered extractant 131 may be directly fed to filter/washer 108, or optionally used as a first stage washing agent or combined with extractant wash 107 in washing the intermediate cellulose material.

In another aspect, as shown in FIG. 2, extractant filtrate 111 may be sent to a flasher 190 to form a vapor stream enriched in co-solvent 191 and a liquid stream enriched in cellulose solvent and hemicellulose 192. Without being bound by theory, the flashing step forms the vapor stream enriched in co-solvent 191 and the liquid stream 192 due to the low to negligible vapor pressure of cellulose solvent and the significant higher vapor pressure of co-solvent. As shown in FIG. 2, vapor stream 191 may be condensed in condenser 180 to form water stream 181 and co-solvent stream 183. Either a pressure drop from filter 110 to flasher 190 or additional energy supply can drive the separation of the cellulose solvent from the co-solvent in the flasher. Flasher 190 may be operated at a pressure from 1 to 10,000 kPa, e.g., from 10 to 5,000 kPa, or from 100 to 1,000 kPa and at a temperature from 0° C. to 300° C., e.g., from 20° C. to 200° C., or from 80° C. to 160° C. In some embodiments, the extracting step is conducted at a higher pressure than the flashing step, e.g., a pressure at least 3% higher, e.g., at least 10% higher, at least 20% higher, or at least 30% higher. In other embodiments, the flashing step is conducted at a pressure lower than the extracting step, e.g., a pressure at most 97% of the pressure of the extracting step, e.g., at most 90% or at most 80%. Exemplary compositions for liquid stream 192 and vapor stream 191 are provided in Table 5.

TABLE 5
FLASHER 190

| | | |
|---|---|---|
| Conc. (wt. %) | Conc. (wt. %) | Conc. (wt. %) |

Liquid Stream 192

| | | | |
|---|---|---|---|
| Cellulose | 0.002 to 18 | 0.003 to 13 | 0.004 to 10 |
| Hemicellulose* | 0.01 to 20 | 0.05 to 19 | 0.08 to 18 |
| Solvent | 0.09 to 99.5 | 1 to 90 | 2 to 81 |
| (e.g., Ionic Liquid) | | | |
| Co-solvent | 0.02 to 99.2 | 2.5 to 97.1 | 4.8 to 96.0 |
| (acetonitrile) | | | |
| Water | 0.001 to 9.3 | 0.01 to 9.2 | 0.02 to 7.3 |

Vapor Stream 191

| | | | |
|---|---|---|---|
| Cellulose | <0.001 | <0.0001 | — |
| Hemicellulose* | <0.001 | <0.0001 | — |
| Solvent | <0.001 | <0.0001 | — |
| (e.g., Ionic Liquid) | | | |
| Co-solvent | 60 to 100 | 64 to 100 | 68 to 100 |
| (e.g., acetonitrile) | | | |
| Water | 0 to 40 | 0 to 36 | 0.003 to 32 |

*“Hemicellulose” in these designated streams includes hemicellulose, degraded cellulose and other impurities.

As shown in FIGS. 1 and 2, hemicellulose concentrate 132 or liquid stream 192 may then be fed to precipitator 135 to precipitate hemicellulose therefrom. A precipitation agent may be fed to precipitator 135 via line 133 and combined with hemicellulose concentrate 132 or liquid stream 192 to form a precipitation slurry 136. Precipitator 135 may comprise one or more stirred tanks or other agitation equipment, and may be either batch or continuous. It may utilize electrostatic charge to facilitate precipitation. Precipitation agent 133 may be selected from the group consisting of isopropanol, and butanol; ketone, e.g., acetone, 2-butanone; ninitrile, e.g., acetonitrile, propionitrile, butyronitrile, chloroacetonitrile; ether, e.g., tetrahydrofuran, diethyl ether, dibutyl ether; ester, e.g., methyl acetate, ethyl acetate, propyl acetate, isopropyl acetate, vinyl acetate, propylene carbonate; carboxylic acid, e.g., acetic acid, formic acid; amide, e.g., formamide; halide, e.g., dichloromethane, chloroform, 1-chlorobutane, 1,2-dichlorethane; hydrogencarbon compound; e.g., hexane, 2,2,4-trimethylpentane, benzene, toluene; amine, e.g., ethylamine, butylamine, ethyldiamine; heterocyclic compound, e.g., pyridine, pyrrole, pyrrolidine, piperidine; water, and combinations thereof. Precipitation agent 133 may also comprise a mixture of an alcohol and water, optionally at an alcohol:water mass ratio from 0.9:1 to 20:1 from 1:1 to 20:1 or from 2:1 to 15:1. Precipitation slurry 136 may comprise, for example, from 0.001 to 7 wt. % cellulose, from 0.003 to 34 wt. % hemicellulose, from 0.0003 to 7 wt. % water, from 0.05 to 50 wt. % solvent, and from 50 to 99 wt. % precipitation agent.

In another embodiment, a gas, optionally an inert gas, e.g., nitrogen, may be fed to precipitator 135. In some embodiments, the inert gas is carbon dioxide, optionally supercritical carbon dioxide. In this embodiment, the supercritical carbon dioxide may lead to the formation of a carbon dioxide phase, a solvent phase and a hemicellulose phase. In this aspect, hemicellulose is automatically separated out as a solids rich stream. The carbon dioxide may be flashed under low pressure, recovered using a compressor, and returned to precipitator 135. Some or all of the co-solvent may be flashed at reduced pressure and recycled (not shown). This type of concentrating process for hemicellulose may advantageously reduce the downstream washing requirements and associated energy costs (described below).

In embodiments where only very small amount of water exists in liquid stream 192 from the flash separation step, vapor stream 191 may be condensed as shown in FIG. 2 or may be used elsewhere in the process, such as in washing step in cellulose purification zone 115. Liquid stream 192 may then be fed directly to precipitator 135 to precipitate hemicellulose therefrom at temperature from 0° C. to 100° C. using a precipitation agent other than water, as shown in FIG. 2. In embodiments where more water exists in liquid stream 192 from the flash separation step, liquid stream 192 may first be separated in distillation column 185 to form distillate 182 and residue 186, as shown in FIG. 3. Distillate 182 preferably comprises from 1 to 20 wt. % water, e.g., from 5 to 15 wt. % water, and from 80 to 99 wt. % co-solvent, e.g., from 85 to 95 wt. % co-solvent. Distillate 182 may be directed to separator 195 to form a water stream 197 and a co-solvent stream 196. Each of streams 191 and 192 may be recycled for use within the process. Residue 186 preferably comprises from 0.1 to 10 wt. % hemicellulose, e.g., from 0.5 to 7.5 wt. % hemicellulose, from 0.05 to 2 wt. % cellulose, e.g., from 0.1 to 1 wt. % cellulose, from 10 to 50 wt. % co-solvent, e.g., from 25 to 45 wt. % co-solvent, and from 20 to 99 wt. % ionic liquid, e.g., from 50 to 70 wt. % ionic liquid. Residue 186 may be directed to precipitator 135. Without being bound by theory, by separating liquid stream 192 prior to directing liquid stream 192 to precipitator 135, the water concentration in precipitator 135 may be reduced, leading to lower water concentration in stream 167 which is separated from the precipitation agent in distillation column 165. Stream 167 may be combined with extractant 104 as shown in FIG. 3. The lower concentration of water in the extractor may lead to higher dissolution of hemicellulose and degraded cellulose in the extractant and/or less consumption of extractant.

In embodiments where residue 186 is directed to precipitator 135, precipitation slurry 136 may comprise, for example, from 0.001 to 3 wt. % cellulose, from 0.001 to 15 wt. % hemicellulose, from 1 to 10 wt. % water, from 0.05 to 50 wt. % solvent, from 0.05 to 50 wt. % co-solvent, and from 10 to 60 wt. % precipitation agent.

As shown in FIG. 1, precipitation slurry 136 may then be sent to filter/washer 137 which separates a precipitation agent filtrate 139 from recovered solid hemicellulose. Filter/washer 137 may comprise solid-liquid separation equipment, including but not limited to rotary vacuum drums, belt filters and screw presses. Prior to exiting filter/washer 137, the recovered solid hemicellulose may be washed with precipitant wash 134 to form washed recovered solid hemicellulose 138. The washing step may serve to further reduce the amount of extractant and/or precipitation agent remaining in the recovered solid hemicellulose. The washing may be conducted in a batch, a semi-batch or a continuous process with material flowing either co-current or counter-current in relation to one another.

In another embodiment, the precipitator may comprise a crystallizer as long as the hemicellulose solubility is sensitive to solvent temperature. In this aspect, the reduced temperature may cause the hemicellulose to precipitate as solids from the solution.

Precipitant wash 134 preferably comprises a co-solvent, which dissolves the impurities inside the hemicellulose, but may also include some low level of cellulose solvent, e.g., ionic liquid or amine oxide, resulting from the sequence of washing steps. In one embodiment, the precipitant wash is selected from the group consisting of the group of alcohol, e.g., methanol, ethanol, iso-propanol, and butanol; ketone, e.g. acetone, 2-butanone; ninitrile, e.g., acetonitrile, propionitrile, butyronitrile, chloroacetonitrile; ether, e.g., tetrahydrofuran, diethyl ether, dibutyl ether; ester, e.g., methyl acetate, ethyl acetate, propyl acetate, isopropyl acetate, vinyl acetate, propylene carbonate; carboxylic acid, e.g., acetic acid, formic acid; amide, e.g., formamide; halide, e.g., dichloromethane, chloroform, 1-chlorobutane, 1,2-dichlorethane; hydrogencarbon compound; e.g., hexane, 2,2,4-trimethylpentane, benzene, toluene; amine, e.g. ethylamine, butylamine, ethyldiamine; heterocyclic compound, e.g., pyridine, pyrrole, pyrrolidine, piperidine; water, and combinations thereof. In another embodiment, precipitant wash 134 is selected from the group consisting of DMSO, DMF, N-methyl pyrrolidone, methanol, ethanol, isopropanol, dimethyl carbonate, propylene carbonate, acetone, water, and mixtures thereof. The precipitant wash may then be removed via line 139 with the precipitation agent filtrate.

Precipitation agent filtrate 139 may be fed to separation equipment, e.g., a membrane or a distillation column 150, to form recovered precipitant wash 151, recovered precipitation agent 152 and second recovered extractant 153. Recovered precipitant wash 151 preferably comprises high concentration, e.g., at least 95 wt. % precipitant wash, e.g., water, and may be recycled and become a first stage precipitant wash stream or part of stream 134. Recovered precipitation agent 152 preferably comprises high concentration, e.g. at least 80 wt. % precipitation agent, optionally greater than 85 wt. % precipitation agent, e.g., an alcohol such as ethanol, and optionally at most 20 wt. % precipitant wash, optionally at most 10 wt. % precipitant wash, e.g., water, and may be recycled and combined with precipitation agent in line 133. Second recovered extractant 153 preferably comprises high concentration, e.g. at least 80 wt. % co-solvent, e.g., at least 85 wt. % co-solvent (e.g., DMSO), and at most 20 wt. % cellulose solvent, e.g., at most 15 wt. % cellulose solvent (e.g., ionic liquid or amine oxide). The second recovered extractant may be recycled and combined with extractant 104. When distillation is employed, column 150 may be operated at a temperature from 0° C. to 300° C., e.g., from 10° C. to 200° C. or from 25° C. to 150° C. and at a pressure (absolute) from 1 to 2,000 kPa, e.g., from 2 to 1,000 kPa, from 5 to 800 kPa or from 10 to 600 kPa. At least a portion of the overhead stream 152 may be returned as reflux to improve separation (not shown). In some embodiments, a second distillation column (not shown) may be used to separate residual cellulose solvent and/or co-solvent from the recovered precipitant wash 151.

Returning to washed hemicellulose 138, the stream may then be mechanically de-liquored, e.g., concentrated in a concentrator 144 to form concentrated hemicellulose material 143 and a second residual precipitant wash 145 that may be combined with precipitant wash 134. The solids content in concentrated hemicellulose material 143 may be from 10 to 99 wt. %, e.g., from 20 to 90 wt. % or from 30 to 85 wt. %. Concentrated hemicellulose material 143 may comprise from 0.1 to 20 wt. % cellulose (e.g., from 1 to 15 wt. % cellulose), from 20 to 99 wt. % hemicellulose (e.g., from 30 to 90 wt. % hemicellulose), and from 1 to 75 wt. % water (e.g., from 10 to 70 wt. % water). The concentrator may include squeeze rolls, rotating rolls, and/or wringer rolls. It should be understood that additional water removal methods may be used to concentrate the hemicellulose, depending on the desired solids content and available energy supply.

Concentrated hemicellulose material 143 or 138 may then be further dried in dryer 146. Hot gas may be fed to dryer 146 via line 148 and may exit dryer 146 via line 149. A finished hemicellulose product may then exit dryer 146 via line 147. The dryer may function to remove residual precipitant wash, e.g., water. Exemplary dryers may include disintegrator dryers, flash dryers, apron dryers, rotary dryers, heated rolls, infrared dryers, ovens and vacuums. The finished hemicellulose product 147 may comprise from 1 to 25 wt. % cellulose (e.g., from 5 to 20 wt. % cellulose), from 60 to 99 wt. % hemicellulose (e.g., from 70 to 95 wt. % hemicellulose), and from 1 to 30 wt. % water (e.g., from 3 to 20 wt. % water).

As shown in FIGS. 2 and 3, filter/washer 137 may be replaced with filter 160. Precipitation slurry 136 may be directed to filter 160 to form a precipitation agent filtrate 161 and a filtered intermediate hemicellulose 162. Filter 160 may comprise solid-liquid separation equipment, including but not limited to rotary vacuum drums, belt filters, centrifuge, and screw presses. Without being bound by theory, the pressure difference between precipitation slurry 136 and filtrate stream 161 may serve as the driving force for filtration. The pressure difference may vary from 1 to 10,000 kPa, e.g., from 10 to 5,000 kPa, or from 100 to 1,000 kPa. Precipitation agent filtrate 161 may be directed to a distillation column 169 to form a distillate 163 comprising precipitation agent and a residue 164 comprising cellulose solvent and co-solvent. In one embodiment, distillate 163 may comprise from 0.1 to 25 wt. % water, from 5 to 40 wt. % co-solvent, from 45 to 90 wt. % precipitation agent and less than 0.0001 cellulose solvent (e.g., substantially free of cellulose solvent). Distillate 163 may be combined with precipitation agent 133 or may be sent directly to precipitator 135 (not shown). Residue 164 may comprise from 20 to 70 wt. % cellulose solvent and from 20 to 80 wt. % co-solvent. Residue 164 may be returned directly to extractor 105 via line 104 or may be combined with fresh extractant and then directed to extractor 105 via line 104. Column 165 may be operated at a temperature from 0° C. to 300° C., e.g., from 10° C. to 200° C. or from 25° C. to 150° C. and at a pressure (absolute) from 1 to 10,000 kPa, e.g., from 5 to 4,000 kPa, or from 3 to 1,000 kPa.

After exiting filter 160, filtered intermediate hemicellulose 162 may be directed to washer 170 where it is washed with precipitant wash 173 as shown in FIG. 2, to further reduce the amount of precipitation agent remaining in the intermediate cellulosic product as well as cellulose solvent. In another embodiment, as shown in FIG. 3, the precipitant wash may co-solvent stream 196 from separator 195. The washing may be conducted in a batch, a semi-batch or a continuous process with material flowing either co-current or counter-current in relation to one another. In some embodiments, only one washing step is used. In other embodiments, as shown, filtered intermediate hemicellulose 162 may be washed more than once in separate washers 170 and 175. When more than one washing step is used, e.g. two or three washing steps, the composition of the precipitant wash may vary in the different washing steps. For example, a first washing step may use acetonitrile, e.g., at least 90 wt. % acetonitrile, as precipitant wash 173 or 196 to remove residual precipitation agent and cellulose solvent and a second washing step may use water as precipitant wash 177, e.g. at least 90 wt. % water, to remove residual acetonitrile. Depending upon the washing agents, the washing temperature may vary broadly, e.g., from 0° C. to 100° C. Typically, a higher temperature can help dissolve more residuals and enhance the mass transfer. A similar configuration can be designed and optimized based upon the general chemical engineering principles and process design theory and it is understood that multiple washing steps, optionally with drying steps in between, may be used.

Precipitant washes 173, 196 and 177 may preferably be substantially free of the cellulose solvent. Further, precipitant wash 173 and 196 preferably have high solubility to cellulose solvent but low solubility to mono-, di-, and oligo-saccharide and other side products. In one embodiment, precipitant wash 173 or 196 is selected from, but not limited to, the group of alcohol, e.g. methanol, ethanol, iso-propanol, and butanol; ketone, e.g. acetone, 2-butanone; ninitrile, e.g. acetonitrile, propionitrile, butyronitrile, chloroacetonitrile; ether, e.g. tetrahydrofuran, diethyl ether, dibutyl ether; ester, e.g. methyl acetate, ethyl acetate, propyl acetate, isopropyl acetate, vinyl acetate, propylene carbonate; carboxylic acid, e.g. acetic acid, formic acid; amide, e.g formamide; halide, e.g. dichloromethane, chloroform, 1-chlorobutane, 1,2-dichlorethane; hydrogencarbon compound; e.g. hexane, 2,2,4-trimethylpentane, benzene, toluene; amine, e.g. ethylamine, butylamine, ethyldiamine; heterocyclic compound, e.g. pyridine, pyrrole, pyrrolidine, piperidine; water, and combinations thereof. The precipitant wash may be enriched in co-solvent and may comprise a condensed portion of the vapor stream of the co-solvent from the flashing step. In another embodiment, the precipitant wash may comprise a stream enriched in precipitation agent.

On the other hand, when high purity hemicellulose material 162 is used, precipitant wash 173 or 196 preferably has the high solubility to side products and is selected from, but not limited to, the group of water, ethylene glycol, glycerin, formamide, N,N-dimethylformamide, N-methylpyrrolidinone, N,N-dimethylacetamide, DMSO, mixture of water and alcohol, and/or their combinations. As shown in FIG. 2, precipitant wash 173 may then be removed via line 172 and returned to precipitator 135. In another embodiment, as shown in FIG. 3, precipitant wash 196 may be removed via line 174 and directed to distillation column 165 to form distillate 166, which is directed to precipitator 135, and residue 167, which is combined with extractant 104. Without being bound by theory, when the ratio of washing agent to solid is high for washer 170, e.g. greater than 10:1, by directing used precipitant wash 172 to distillation column 165 instead of directing it to precipitator 135, efficiency of the process may be improved. In this aspect, co-solvent in used precipitant wash 172 is separated from the precipitation agent in distillation column 165 and thus the concentration of precipitation agent in the precipitator 135 is improved. Precipitant wash 177 may then be removed via line 178 and recycled within the process, optionally after further treatment using distillation operations, membrane technology, and/or other technologies.

Exemplary compositions using ethanol as precipitating agent 133, acetonitrile as precipitant wash 173 or 196 and water as precipitant wash 177 are provided in Table 6. If no further processing is required, washed hemicellulose 162 may be referred to as a finished hemicellulose product in which the ratio of hemicellulose concentration to cellulose concentration is at least 5 times higher than in feed stream 103.

TABLE 6
FILTER 160, WASHER 175 and WASHER 175

| | | |
|---|---|---|
| Conc. (wt. %) | Conc. (wt. %) | Conc. (wt. %) |

Filtered Hemicellulose 162

| | | | |
|---|---|---|---|
| Cellulose | 0.01 to 80 | 0.01 to 79 | 0.02 to 78 |
| Hemicellulose* | 0.07 to 80 | 0.4 to 80 | 0.7 to 80 |
| Precipitation Agent | 4.6 to 53 | 4.9 to 50 | 5.1 to 48 |
| (e.g., Ethanol) | | | |
| Solvent | 0.004 to 54 | 0.09 to 49 | 0.1 to 44 |
| (e.g., Ionic Liquid) | | | |
| Co-solvent | 0.001 to 54 | 0.1 to 53 | 0.2 to 52 |
| (e.g., Acetonitrile) | | | |
| Water | 0 to 12 | 0.001 to 12 | 0.001 to 6 |

Washed Hemicellulose 171

| | | | |
|---|---|---|---|
| Cellulose | 0.01 to 80 | 0.01 to 79 | 0.02 to 78 |
| Hemicellulose* | 0.07 to 80 | 0.4 to 80 | 0.7 to 80 |
| Precipitation Agent | 0 to 6.6 | 0 to 5.9 | 0 to 5.3 |
| (Ethanol) | | | |
| Solvent | 0 to 6.7 | 0 to 5.8 | 0 to 4.9 |
| (e.g., Ionic Liquid) | | | |
| Precipitant Wash/Co- | 15 to 67 | 16 to 64 | 17 to 60 |
| solvent | | | |
| (e.g., Acetonitrile) | | | |
| Water | 0 to 4 | 0 to 3.8 | 0 to 1.7 |

Used Precipitant Wash 172

| | | | |
|---|---|---|---|
| Water | 0 to 16 | 0 to 15 | 0 to 6.7 |
| Solvent | 0 to 8.9 | 0 to 7.3 | 0 to 6.6 |
| (e.g., Ionic Liquid) | | | |
| Precipitation Agent | 0.2 to 18 | 0.25 to 16 | 0.3 to 14 |
| (e.g., Ethanol) | | | |
| Precipitant Wash/Co- | 58 to 100 | 62 to 100 | 73 to 100 |
| solvent | | | |
| (e.g., Acetonitrile) | | | |

Washed Hemicellulose 176

| | | | |
|---|---|---|---|
| Cellulose | 0.01 to 80 | 0.01 to 79 | 0.02 to 78.0 |
| Hemicellulose* | 0.07 to 80 | 0.4 to 80 | 0.7 to 80 |
| Water | 20 to 70 | 21 to 67 | 22 to 63 |

Used Precipitant Wash 178

| | | | |
|---|---|---|---|
| Water | 77 to 99.3 | 80 to 99.2 | 82 to 99.1 |
| Co-solvent | 0.7 to 22 | 0.8 to 20 | 0.9 to 18 |
| (e.g., Acetonitrile) | | | |

*“Hemicellulose” in these designated streams includes hemicellulose, degraded cellulose and other impurities.

Returning to washed hemicellulose 171 or 176, the stream may then be mechanically de-liquored (not shown), e.g., concentrated in a concentrator to form concentrated hemicellulose material. The solids content in concentrated hemicellulose material may be from 10 to 99 wt. %, e.g., from 20 to 90 wt. % or from 30 to 85 wt. %. In some embodiments, the solids content is greater than 90 wt. %. The concentrator may include squeeze rolls, rotating rolls, and/or wringer rolls. It should be understood that additional water removal methods may be used to concentrate the hemicellulose, depending on the desired solids content and available energy supply.

In some embodiments, the washer and/or concentrated hemicellulose material may then be further dried in an optional dryer 146, using hot air 148 to form dried cellulose 146. Liquid 149 may be removed from dryer 146. Concentrated hemicellulose streams 171 or 176 may be sent to the dryer. The dryer may function to remove residual precipitant wash, e.g., water. Exemplary dryers may include disintegrator dryers, flash dryers, apron dryers, rotary dryers, heated rolls, infrared dryers, ovens and vacuums.

The finished hemicellulose product has a broad application to generate high value chemicals. Some, but not all, examples are described briefly here. First, it may be advantageously used as an intermediate in furfural, furan derivatives, xylitol, methyl furfural, or valerolactone production. Second, the finished hemicellulose product may also be used as a feedstock to produce ethanol and/or as a fuel to a recovery boiler. Third, hemicellulose can be used as a starting material to produce composite materials and chemicals, such as films, adhesives, packaging, sweeteners, small molecular, polymers, and pharmaceutical formulations. Fourth, it can be recycled back to paper mill to make papers with special features. Fifth, it can be used in a hydrogel, in combination with additional components including cellulose, chitosan, starch, small molecules, and other native or artificial polymers. Sixth, it may be used to form hemicellulose derivatives including hemicellulose esters, ethers, acids, aldehydes, halides, amines, amides, and combinations thereof. The esters may include hemicellulose sulfate, phosphate, acetate, formate, propionate, butyrate, acrylate, benzoate, tosylate, phthalate, trifluoroacetate, and other organic esters comprising from 3 to 18 carbons. The ethers may include hemicellulose methyl ether, ethyl ether, carboxymethyl ether, benzyl ether, allyl ether, acryl ether, and other ethers comprising from 3 to 18 carbons. Seventh, the hemicellulose may be used in combination with other polymers, including polyols, polyamines, polyacids, polyamides, polyethers, polyesters, polystyrenes, polyalkanes, polyalkenes, and mixtures thereof.

While the above invention is applicable to processes in which mono-, di-, and oligo-saccharide and/or other side products may be generated in the extraction process, flashing process, and/or other operating steps, several other technologies can also be chosen to remove them from the system in order to maintain continuous operation. In one embodiment, the process may comprise a first washing step with an alcohol, followed by a washing step with a co-solvent. The alcohol may dissolve cellulose solvent but has limited solubility to mono-, di-, and oligo-saccharides. The co-solvent wash may dissolve mono-, di-, and oligo-saccharides from hemicellulose. In some embodiments, evaporation, membrane, ion exchange, activated carbon bed, simulated moving bed chromatographic separation, flocculant, e.g., polydiallyldimethylammonium chloride (polyDADMAC), and/or their combinations may be employed to separate mono-, di-, and oligo-saccharide from the liquid stream. In other embodiments, polymer-bound boronic acid has been demonstrated to be able to form complex with sugars so that the sugars are separated from the liquid stream. In yet other embodiments, the small sugars may be converted by either enzymatic treatment or acid-catalytic process into furfural, ethanol, acetic acid, and/or other products which can be further separated out from the system. In still other embodiments, mono-, di-, and oligo-saccharide and other side products can be removed in one or more operations, which are located before the separation of the extraction filtrate, after precipitation step, in the hemicellulose wash steps, and/or in other steps. The operating conditions are also determined by the stability of the extractant. Without being bound by theory, this allows for the minimization of degradation products of the extractant. For a continuous operation, degradation products may be removed by directly purging a degradation products stream. Additionally, distillation may be used to purge degradation products from a column as a distillate or a residue, depending on the boiling point(s) of the degradation product(s). In some embodiments, combinations of these degradation product removal strategies may be employed.

Similarly, accumulated dissolved and/or suspended solids may be removed from the system in order to maintain continuous operation. In some embodiments, evaporation, membrane filtration, ion exchange, activated carbon bed, simulated moving bed chromatographic separation, flocculant, e.g. polydiallyldimethylammonium chloride (polyDADMAC), and/or their combinations may be employed to separate the accumulated dissolved and/or suspended solids from the system.

It is understood that the processes described herein may be further modified based upon the extraction capability, stability, and costs of ionic liquid and co-solvent.

The present invention will be better understood in view of the following non-limiting examples.

### VI. Examples

### Example 1

A carbohydrate analysis and a gel permeation chromatography (GPC)/size exclusion chromatography (SEC) analysis of a hemicellulose composition prepared according to the present invention were conducted. The hemicellulose was prepared from hardwood kraft bleached pulp. The hardwood kraft bleached pulp was fed to an extractor along with an extractant comprising 3.0 wt. % EMIM Ac and 97 wt. % of DMSO with a 5% solid/liquid (S/L) loading. The extraction was conducted at 95° C. for 1 hour. After extraction, the extraction mixture was collected by centrifuge. The collected extraction mixture was then added to ethanol (a 1:1 volume ratio to the extraction mixture) as a precipitating agent to precipitate the extracted hemicellulose. The precipitated hemicellulose was left to settle overnight and then filtered. After filtration, the hemicellulose solids were further washed with water four times to remove residual ionic liquid and DMSO co-solvent. The washed hemicellulose was then dried at room temperature in a chemical hood for two to three days. The dried hemicellulose was then subjected to carbohydrate analysis and GPC/SEC analysis.

The carbohydrate analysis was conducted in the following manner. The samples were prepared according to TAPPI T249, incorporated herein by reference in its entirety. Approximately 0.3 gram of pulp was prehydrolyzed in 3 mL of 72% H₂SO₄ at 30° C. for 1 hour. The pulp was then diluted to a 4% H₂SO₄ concentration by adding water. The pulp was autoclaved at 120° C. to completely hydrolyze the polysaccharides into monosaccharides. The hydrolyzed sample was then analyzed by Dionex ion chromatography with a pulsed amperometric detector (PAD). The results were calculated relative to the sample weight on oven-dried basis.

The SEC was conducted using three detectors in series: refractive index (RI), right angle and low angle light scattering (RALS/LALS), and four-capillary differential viscometer. The system was calibrated use a poly(methyl methacrylate) standard. The run conditions were as follows: a mobile phase contained 0.5% lithium chloride in N,N-dimethylacetamide (DMAC); the run was conducted at 60° C., with an injection volume of 100 μL and a flow rate of 0.70 mL/min using Viscotek I-MBLMW and MBHMW SEC/GPC columns.

The hemicellulose sample was prepared by placing approximately 0.05 g of the hemicellulose in 10 mL water at 40° C. to swell for 45 minutes. This was repeated. The sample was then washed twice with 8 mL methanol for 45 minutes at ambient temperature. 8 mL anhydrous DMAC was added twice consecutively at ambient temperature. The first wash of anhydrous DMAC was left for 45 minutes and the second wash was left overnight. The sample was then added to 5 mL of 8% dry LiCl/anhydrous DMAC, heated to 60° C. for 6 hours, and then stirred at room temperature for 20 hours for complete dissolution. The final dissolved sample was a clear viscous mixture of 8% LiCl/DMAC at a concentration of 10 mg/mL. The sample was then diluted to approximately 1 mg/mL before injection into the GPC instrumentation. The results of the analysis are shown in Table 7.

### Comparative Example A

A carbohydrate analysis and a GPC/SEC analysis of a xylan from beechwood (a hard wood), were conducted as in Example 1. The results of the analysis are shown in Table 7.

### Comparative Example B

A GPC/SEC analysis of mannan from saccharomyces cerevisiae (a microbial) prepared by alkaline extraction was conducted as in Example 1. The results of the analysis are shown in Table 7.

TABLE 7
HEMICELLULOSE CARBOHYDRATE
AND GPC/SEC ANALYSIS

| | | |
|---|---|---|
| | Comparative | Comparative |
| Example 1 | Example A | Example B |

Carbohydrate Analysis

| | | | |
|---|---|---|---|
| Arabinan (wt. %) | <0.1 | 0.1 | N/A |
| Xylan (wt. %) | 72.3 | 52.5 | N/A |
| Mannan (wt. %) | <0.1 | 0.3 | N/A |
| Galactan (wt. %) | 0.2 | 0.1 | N/A |
| Glucan (wt. %) | 1.2 | 12.6 | N/A |
| Acid Insoluble (wt. %) | 0.6 | <0.1 | N/A |
| Total (wt. %) | 74.3 | 65.7 | N/A |

GPC/SEC Analysis

| | | | |
|---|---|---|---|
| Weight-Average Molecular | 27,742 | 38,769 | 87,291 |
| Weight (g/mol) | | | |
| Number-Average Molecular | 21,974 | 35,077 | 67,774 |
| Weight (g/mol) | | | |
| Z-Average Molecular | 42,548 | 49,759 | 252,476 |
| Weight (g/mol) | | | |
| Peak Molecular Weight (g/mol) | 27,082 | 36,863 | 78,203 |
| Polydispersity Index | 1.27 | 2.205 | 1.29 |
| Intrinsic Viscosity (dL/g) | 0.35 | 0.38 | 0.15 |
| Hydrodynamic Radius (nm) | 5.14 | 5.44 | 5.74 |

### Example 2

A hemicellulose composition was prepared as in Example 1, except that the extractant comprised 3.5 wt. % EMIM Ac and 96.5 wt. % DMSO. The hemicellulose of Example 1-2 and of Comparative Examples A-B was subjected to elemental analysis. Comparative Example A is a commercial available xylan from beechwood, and comparative Example B is a commercial available mannan from Saccharomyces cerevisiae. The hemicellulose of Examples 1-2 and of Comparative Examples A-B was subjected to elemental analysis. The elemental analysis was conducted by weighing 2 grams of the hemicellulose composition of Example 1 into a digestion tube, adding 10 mL of ultra-pure distillated water to the tubes, and adding 10 mL of trace mineral grade nitric acid to the tube. The sample was then digested for 90 minutes at 95° C. Ultra-pure distilled water was then added to the 50 mL mark on the digestion tube. The tube was shaken by hand to mix and then 10 mL of sample from the tube was placed in a test tube and tested on a Varian 720-EC ICP instrument. This was repeated for Example 2 and Comparative Examples A-B. The results are shown in Table 8.

TABLE 8
HEMICELLULOSE ELEMENTAL ANALYSIS

| Elemental | | | Comparative | Comparative |
|---|---|---|---|---|
| Analysis (ppm) | Example 1 | Example 2 | Example A | Example B |
| Ag | 1 | <0.1 | 0.1 | <0.1 |
| Sn | 9.82 | 1.39 | 0.42 | 0.39 |
| Bi | <0.1 | <0.1 | 0.1 | <0.1 |
| Al | 8.2 | 4.7 | 1.3 | <0.1 |
| As | 0.5 | 0.5 | 0.4 | 0.7 |
| B | 2.8 | 0.9 | 0.8 | <0.1 |
| Ba | 9.7 | 12 | 69.2 | 1.9 |
| Be | <0.1 | <0.1 | <0.1 | <0.1 |
| Ca | 247.2 | 309 | 1426.7 | 54.7 |
| Cd | 2.3 | 0.1 | <0.1 | <0.1 |
| Co | 1.8 | 0.9 | <0.1 | <0.1 |
| Cr | 3.9 | 7.1 | 0.2 | 0.4 |
| Cu | 28.1 | 25.8 | 2.4 | 68.1 |
| Fe | 101 | 68.8 | 95.4 | 42.2 |
| K | 7.4 | 7.6 | 74.1 | 545.3 |
| Mg | 39.3 | 41.5 | 8.2 | 16.5 |
| Mn | 1.8 | 1.9 | 12.5 | 0.1 |
| Mo | 1.7 | 1.3 | 0.3 | <0.1 |
| Na | 77.1 | 172.9 | 14259.3 | 5793.5 |
| Ni | 74 | 1 | 0.3 | 0.5 |
| P | 2.5 | 1.4 | 11.4 | 5558.8 |
| Pb | 100.4 | 4.1 | 0.4 | 0.2 |
| S | 4336.1 | 268.2 | 44.6 | 187.5 |
| Sb | 0.3 | <0.1 | <0.1 | <0.1 |
| Se | 0.5 | 0.6 | 0.3 | <0.1 |
| Ti | 9.3 | 3.1 | 1.1 | 0.4 |
| Tl | <0.1 | <0.1 | 0.1 | <0.1 |
| V | <0.1 | <0.1 | 0.1 | <0.1 |
| Zn | 85.1 | 62.1 | 6.7 | 5.2 |

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A hemicellulose composition comprising from 55 to 99 wt. % xylan, based on the total dried weight of the hemicellulose composition.

2. The hemicellulose composition of claim 1, wherein the composition comprises from 55 to 80 wt. % xylan.

3. The hemicellulose composition of claim 1, wherein the composition comprises less than 0.3 wt. % mannan.

4. The hemicellulose composition of claim 1, wherein the composition comprises less than 0.1 wt. % mannan.

5. The hemicellulose composition of claim 1, wherein the composition comprises less than 5 wt. % glucan.

6. The hemicellulose composition of claim 1, wherein the composition comprises less than 0.1 wt. % arabinan.

7. The hemicellulose composition of claim 1, wherein the weight ratio of xylan to mannan is at least 200:1.

8. The hemicellulose composition of claim 1, wherein the weight ratio of xylan to mannan is at least 500:1.

9. The hemicellulose composition of claim 1, wherein the composition has a weight average molecular weight from 20,000 to 35,000 g/mol.

10. The hemicellulose composition of claim 1, wherein the composition has a number average molecular weight from 10,000 to 40,000 g/mol.

11. The hemicellulose composition of claim 1, wherein the composition has a Z-average molecular weight from 20,000 to 45,000 g/mol.

12. The hemicellulose composition of claim 1, wherein the composition has an intrinsic viscosity of at least 0.3.

13. The hemicellulose composition of claim 1, wherein the composition has an intrinsic viscosity of at least 0.34.

14. The hemicellulose composition of claim 1, wherein the composition comprises less than 5000 ppm sodium.

15. The hemicellulose composition of claim 1, wherein the composition comprises less than 250 ppm sodium.

16. The hemicellulose composition of claim 1, wherein the composition comprises less than 5000 ppm potassium.

17. The hemicellulose composition of claim 1, wherein the composition comprises less than 70 ppm potassium.

18. The hemicellulose composition of claim 1, wherein the hemicellulose composition is derived from a hardwood pulp.

19. A hemicellulose composition comprising xylan and mannan in a weight ratio from 200:1 to 2000:1.

20. A hemicellulose composition comprising from 55 to 99 wt. % xylan, less than 0.3 wt. % mannan, less than 5 wt. % glucan and less than 0.1 wt. % arabinan.
